(19) United States
(12) Patent Application Publication
(10) Pub. No.: US 2026/0147876 A1
(43) Pub. Date: May 28, 2026

(54) INTERCEPTORS TO REQUESTS EXTERNAL TO AN APPLICATION SECURITY MANAGEMENT SYSTEM FOR EVALUATION AND LOGGING

(71) Applicant: Oracle International Corporation, Redwood Shores, CA (US)

(72) Inventors: Mark Vakoc, Evergreen, CO (US); Vineet Tyagi, New South Wales (AU); Mohammad Haseeb, Melbourne (AU); Ravi Bhojani, Melbourne (AU)

(73) Assignee: Oracle International Corporation, Redwood Shores, CA (US)

(21) Appl. No.: 18/963,108

(22) Filed: Nov. 27, 2024

(51) Int. Cl. G06F 21/55

(52) U.S. Cl. CPC G06F 21/552; G06F 2221/034

(57) ABSTRACT

Systems, methods, and computer-readable media are provided for implementing an application security management system. An application instance is executed that uses an interface that wraps external resource access functionality of the application instance. The interface is used to allow access from the application instance to one or more external resources, and an application security management system managing the interface logs requests. A call is received including a request for access to a resource external to the application instance along with metadata about functionality carried out by the application instance in association with the request. A use-case is determined for the request based at least in part on the metadata. The use-case is compared to a set of rules that map different use-cases to different candidate external resources to determine if the request to the resource is valid for the use-case. When the resource is not valid for the use-case, the request is rejected and logged.

### BACKGROUND

An application, when executed on a device, may have access to resources external to the application within the device. For example, these resources may be used or shared by other applications or may be provided by special-purpose hardware of the device. Applications use these external resources to expand application functionality and make use of the shared resources or special-purpose hardware.

Access to expanded functionality from external resources may create security risks for a user of the device if such access is used maliciously by the application. For example, information from the external resources may be used to spy on or leak information about the user of the device. The user may misplace trust in otherwise trusted applications without knowing of these security risks. In some instances, the user may not have many other options than to allow access to external resources in order to obtain the benefit of the expanded functionality offered by an application.

Accordingly, device users are left with the Hobson's choice of enjoying the expanded functionality of an application by granting access to any external resources requested by the application, or not using the application at all. Application developers with popular applications may take advantage of this dilemma by extracting more personal or sensitive information about their users than any ordinary user would expect. Some sensitive information accessible via these external resources may expose classified information that presents a national security threat, competitive information that poses unforeseen business risks, and other sensitive information that poses a risk to a business's or individual's reputation. For applications that are used frequently in the everyday lives of users, these risks are currently unavoidable for technology adopters.

### BRIEF SUMMARY

In some embodiments, a computer-implemented method includes controlling an application's access to resources based on application status and/or other metadata.

Systems, methods, and computer-readable media are provided for implementing an application security management system. An application instance is executed that uses an interface that wraps external resource access functionality of the application instance. The interface is used to allow access from the application instance to one or more external resources, and an application security management system managing the interface logs requests. A call is received including a request for access to a resource external to the application instance along with metadata about functionality carried out by the application instance in association with the request. A use-case is determined for the request based at least in part on the metadata. The use-case is compared to a set of rules that map different use-cases to different candidate external resources to determine if the request to the resource is valid for the use-case. When the resource is not valid for the use-case, the request is rejected and logged.

In one embodiment, a computer-implemented method includes executing an application instance that uses an interface that wraps external resource access functionality of the application instance. The interface may be configured to constrain external resource access functionality based at least in part on information obtained from the application instance about states of the application instance. The computer-implemented method also includes using the interface to allow access from the application instance to one or more external resources, and logging, in a particular log, metadata about functionality carried out by the application instance in relation to access to the one or more external resources. The computer-implemented method includes receiving a call to the interface from the application instance, where the call includes a request for particular access to a particular resource external to the application instance, and receiving particular metadata about functionality carried out by the application instance in association with the request. The computer-implemented method also includes determining a particular use-case of a plurality of candidate use-cases for the request based at least in part on the particular metadata and comparing the particular use-case to a set of rules that map different use-cases of the plurality of candidate use-cases to different candidate external resources to determine if the request to the particular resource is valid for the particular use-case, where the set of rules is based at least in part on a first set of historical requests to external resources that are invalid and a second set of historical requests to external resources that are valid. Based on a determination that the request to the particular resource is not valid for the particular use-case, the request between the application instance and the particular resource external to the application instance is rejected and the rejected request is logged to the particular log.

In a further embodiment, the determination that the request to the particular resource is not valid for the particular use-case is based at least in part on a determination that the particular use-case for the request does not satisfy a particular rule, and the computer-implemented method includes logging the determination for the particular rule to the particular log in association with the rejected request.

In a further embodiment, the resource external to the application may be a hardware component of a device on which the application instance is executed.

In a further embodiment, the resource external to the application may be a cache server for the application instance. The request may be to access cached data stored on the cache server. The computer-implemented method also includes generating an initial hash value of the cached data of the cache server. In response to receiving the call to the interface from the application instance, a current hash value of the cached data of the cache server may be generated. The computer-implemented method also includes comparing the initial hash value and the current hash value, where the determination that the request to the particular resource is not valid for the particular use-case is based at least in part on the initial hash value being different from the current hash value.

In a further embodiment, the computer-implemented method also includes determining the particular resource external to the application instance is a content distribution network, adding a security header to the request that restricts access of the content distribution network to external data sources for generating a response to the request, and sending the request to the content distribution network.

In a further embodiment, the computer-implemented method also includes obtaining a current state of the particular resource, where the determination that the request to the particular resource is not valid for the particular use-case is based at least in part on the current state of the particular resource.

In a further embodiment, the computer-implemented method also includes, in response to the determination that the request to the particular resource is not valid for the particular use-case, recording user input to validate the request to the particular resource.

In a further embodiment, using the interface to allow access from the application instance to the one or more external resources includes connecting to the one or more external resources, retrieving particular data from the particular resource, using a machine learning model to determine a subset of the particular data that is permitted for access by the application instance, and sending the subset of data to the application instance.

In a further embodiment, the computer-implemented method also includes receiving a new rule from an application security service, where the new rule is based at least in part on analysis of the particular log. The computer-implemented method also includes storing the new rule in the set of rules, where the determination that the request to the particular resource is not valid for the particular use-case is based at least in part on the new rule.

In a further embodiment, the set of rules is one set of rules of a plurality of sets of rules and each set of rules of the plurality of sets of rules is associated with a region. The set of rules may be used due to the region associated with the set of rules being the region associated with the application instance.

In some embodiments, a system is provided that includes one or more data processors and a non-transitory computer-readable storage medium containing instructions which, when executed on the one or more data processors, cause the one or more data processors to perform part or all of one or more methods disclosed herein.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1A illustrates a flow chart of an example process for intercepting and evaluating application requests to resources.

FIG. 1B illustrates a flow chart of an example process that uses bytecode injection to control an application's access to resources.

FIG. 1C illustrates a flow chart of an example process that controls an application's access to sensors based on application status and/or other metadata.

FIG. 2 illustrates a flow chart of an example process that analyzes and monitors resource access requests by an application security management system.

FIG. 3 illustrates a diagram of an example application security management system for controlling an application's access to resources based on application status and/or other metadata.

FIG. 4 illustrates a diagram of an example user interface showing a configuration interface for configuring rules to apply for controlling an application's access to resources based on application status and/or other metadata.

FIG. 5A illustrates a diagram of an example user interface for a content consumption and collaboration application with data security managed by an application security management system.

FIG. 5B illustrates a diagram of an example user interface for a content consumption and collaboration application where an application security management system has blocked or delayed a resource access request based on one or more rules and displayed a warning about the block or delay of the resource access.

FIG. 5C illustrates a diagram of an example user interface for a content consumption and collaboration application where an application security management system has blocked or delayed a display of content based on one or more rules and displayed a warning about the block or delay of the display of content.

FIG. 6 depicts a simplified diagram of a distributed system for implementing certain aspects.

FIG. 7 is a simplified block diagram of one or more components of a system environment by which services provided by one or more components of an embodiment system may be offered as cloud services, in accordance with certain aspects.

FIG. 8 illustrates an example computer system that may be used to implement certain aspects.

### DETAILED DESCRIPTION

In various embodiments, an application instance is executed that uses an interface that wraps resource access functionality of the application instance. The interface receives a call including a request for access to a resource, such as a resource external to the application instance. A use-case is determined for the request and is compared to a set of rules that map different use-cases to different candidate resources to determine if the request to the resource is valid for the use-case. When the resource is not valid for the use-case, the request is rejected and logged.

In various embodiments, controlling an application's access to resources based on application status and/or other metadata is implemented using non-transitory computer-readable storage media to store instructions which, when executed by one or more processors of a computer system, cause resource access or not and log resource access requests and results. The logged resource access requests may be accessible to an external service for synchronously or asynchronously evaluating whether resource access requests should be more or less constrained going forward based on observed patterns. Adjustments to rules for handling resource access requests may be made as a result of the evaluation.

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Intercepting Requests for Evaluation and Logging

An instance of the application may be executed using an application security management system that prevents a security risk of the application accessing resources for illegitimate purposes. The application instance may be executed using an application security interface that wraps resource access functionality of the application instance such that requests made by the application instance to certain resources, such as resources external to the application instance, pass through the application security interface. An application security management system accessing requests via the application security interface may be configured to constrain resource access functionality based on information obtained about states of the application instance. The information about the states of the application instance may be obtained from the application instance, for example, via an external-facing communication such as an external resource call. The information obtained about states of the application instance may also be obtained from the device or various resources of the device.

The application security interface and/or application security management system may be implemented such that the interface is implemented within or used by application code in an application build pipeline for assembling the application which may be instantiated on a device such as a mobile device. The application security management system intercepts requests for connections external to the application instance, and the application security management system analyzes the requests to determine if the requests comply with security policies or attempt to expose user data or breach user privacy expectations. Requests are also logged for further processing, and the application security management system may use sampling and/or artificial intelligence to narrow down requests for further analysis. The requests for further analysis may be sent as traffic to security review endpoints for synchronous or asynchronous analysis.

Decompilation of the application security management system may be prevented by obfuscating the code to be integrated using encryption based on one or more keys private to the vendor of the application security management system and not shared with the application vendor. The application security management system's rules may be dynamically updated on the back-end to adjust traffic that is allowed and disallowed going forward based on the analysis, without requiring app store releases or software updates.

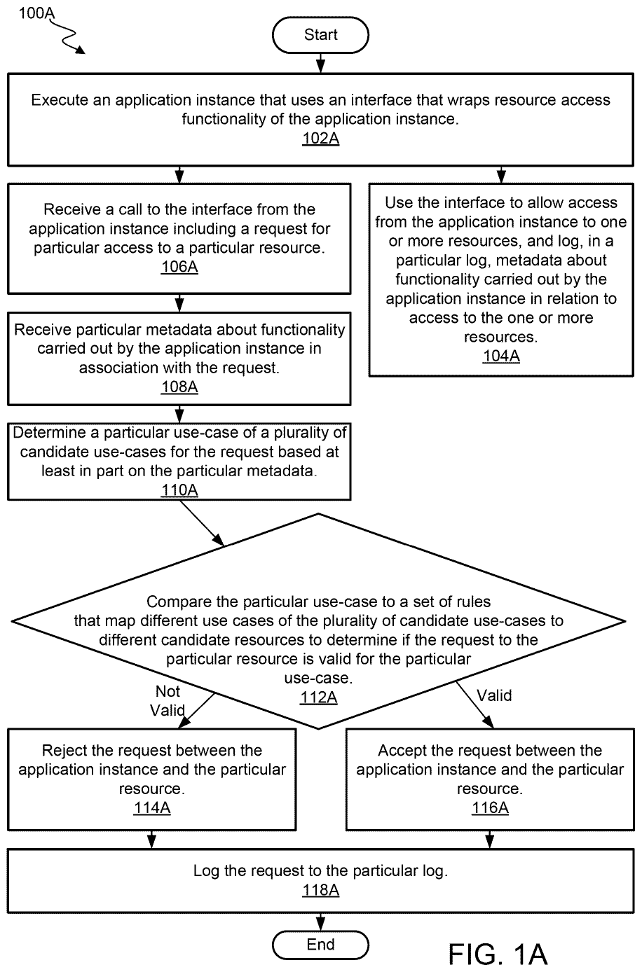

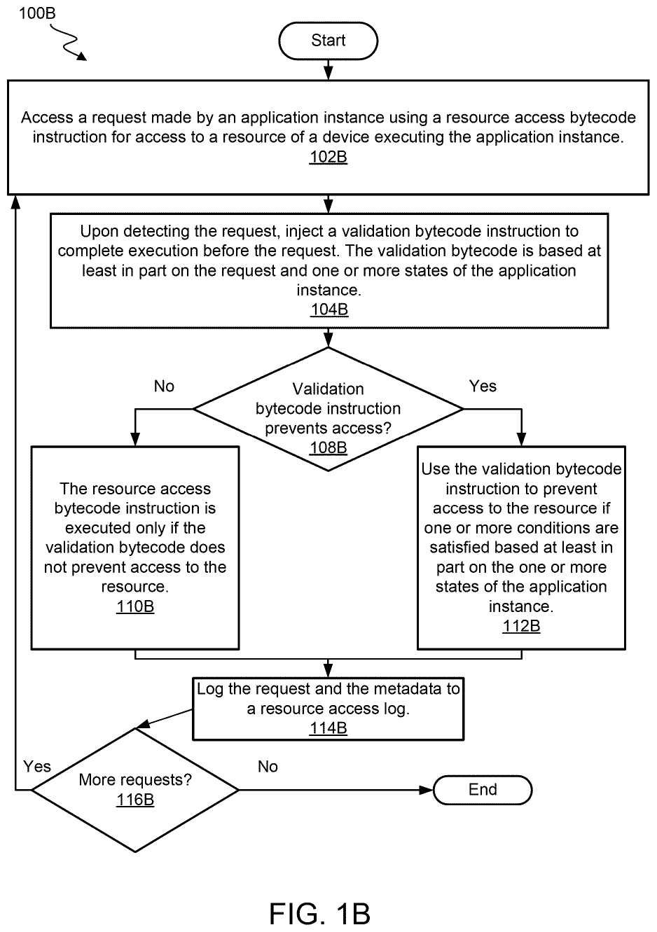

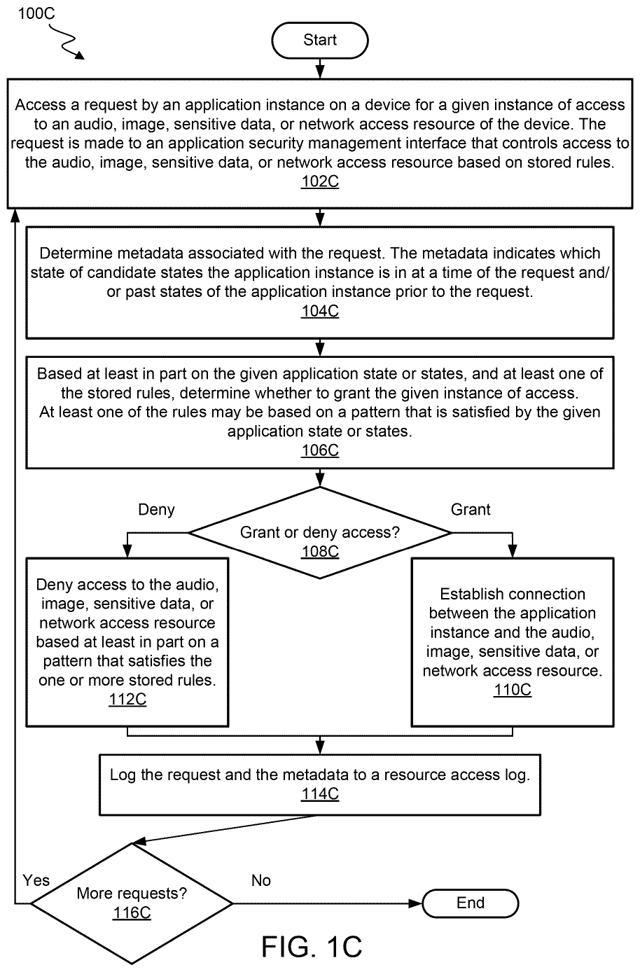

FIG. 1A depicts a flow chart of an example process 100A for evaluating requests by an application to resources. At block 102A, an application instance is executed that uses an interface that wraps resource functionality of the application instance. The interface may be configured to constrain resource access functionality based at least in part on information obtained from the application instance about states of the application instance. At block 104A, the interface may be used to allow access from the application instance to one or more resources and log in a particular log metadata about functionality carried out by the application instance in relation to access to the one or more resources. At block 106A, a call may be received by the interface from the application instance including a request for particular access to a particular resource, such as a resource external to the application instance. At block 108A, particular metadata may be received where the particular metadata is about functionality carried out by the application instance in association with the request. At block 110A, a particular use-case may be determined from a plurality of candidate use-cases for the request based at least in part on the particular metadata. At block 112A, a comparison is made between the particular use-case and a set of rules that map different use-cases of the plurality of candidate use-cases to different candidate resources to determine if the request to the particular resource is valid for the particular use-case. The set of rules may be based at least in part on a first set of historical accesses requests to resources that are invalid and a second set of historical accesses requests to resources that are valid. If the comparison results in the determination that the request to the particular resource is not valid for the particular use-case, at block 114A, the request between the application instance and the particular resource is rejected. If the comparison results in the determination that the request to the particular resource is valid for the particular use-case, at block 116A, the request between the application instance and the particular resource is accepted. At block 118A, the request is logged to the particular log.

The application security management system may receive, via the application security interface, a call. The call may include a request for particular access to a particular resource such as a resource external to the application instance. The request may be any sort of attempted access of a resource. A requested particular resource may be said to be external to the application instance if the requested particular resource exists independently of the application instance on the device, such that the requested particular resource is accessible through the application security interface by the application instance. Alternatively, a requested particular resource may be considered external to the application instance if the application instance cannot access the requested particular resource or does not possess existing access permissions or credentials for accessing the requested particular resource without passing through the application security interface. For example, an application instance may have access permissions to the file storage of a device, in which case the application instance may have a particular partition of data files for the application instance which may be said to be part of the application instance. However, an application instance may not have existing credentials or access permission to a camera resource, a microphone resource, a Global Positioning System (GPS) or other location sensing resource, a data repository storing sensitive data, and/or a network access resource such as an intermediate endpoint or network interface of the device. For example, a sandbox may check outbound network requests to ensure they go to an approved destination. As defined herein, “sensitive data” may include any access-restricted data that is confidential to one or more users, such as user-specific data, and divulging “sensitive data” without separate authorization may impinge on the privacy rights of the user(s) for which the sensitive data was gathered. In this example, the camera resource, microphone resource, location-sensing resource, data repository storing sensitive data, and/or network access resource may be considered external to the application instance if the application instance makes a call to such resource that is managed by an access manager external to the application instance. A requested particular resource may also be considered external to the application instance if the requested particular resource is a portion of a resource that is beyond the current scope of access given to the application instance. For example, an application instance may have access permissions to a memory resource responsible for at least partial execution of the application instance. However, the memory resource may also be responsible for execution of other processes currently run or executed on the device. The portion of the memory resource that is partitioned or responsible for the execution of the application instance may be considered as a resource that the application instance has permissions for or is internal to the application instance; whereas, a portion of the memory resource that is partitioned or responsible for the execution of another process unrelated to the application instance may be considered external to the application instance. The portion of memory that is responsible for execution of other processes may exist independently and persist before and/or after existence of the application instance on the device.

In another embodiment, access to resources even internal to the application instance may be monitored for data collection. For example, an application may have access to a data repository for storing or managing user-specific information or other sensitive information, and access to the resource may be monitored and managed by an access manager internal to the application instance to determine whether such access should be granted based on a state of the application and/or other metadata at a time the request was made or at times leading up to the request for access. For example, if a user interacts with an application, and that application collects behavioral patterns specific to the user (including, for example, an identification of the items viewed by the user during application sessions), the application security management system may ensure that the collected user-specific or otherwise sensitive data (e.g., the behavioral patterns) are handled appropriately (e.g., not transmitted to an unapproved third party over the network).

Whether managing internal requests for resource access or external requests for resource access, the application security management system may comprise one or more rules-based interceptors which target specific types of requests by the application instance and analyze data sharing paths in mobile applications or other applications. The one or more interceptors may detect a call or request via comparison to a set of code or language common to the type of request specific to the one or more interceptors. The one or more interceptors may apply rules against information about a request to determine whether the request is valid. After making a determination for the request based on the set of rules, the one or more interceptors may perform actions to block the request or allow or facilitate the request's completion. The interceptors can prevent protected data from going to unauthorized locations/endpoints for users that satisfy certain criteria, such as users from a particular region. Interceptors integrate with supporting implementation in the application instance. In one embodiment, activation logic in the application instance enables protections when the application instance is used by users that satisfy the certain criteria, and disables protections for users that do not satisfy the certain criteria.

A particular type of interceptor used is code that processes a request from an application instance to determine a use-case and/or type of access that is requested (e.g., a network for which access is requested, a requested third-party interaction, a request to access sensor data collected by a sensor in a user device, etc.). If an interceptor detects that the application instance is requesting to connect to a resource, the application security management system may be passed a data-flow ID that indicates a purpose for the resource usage requested by the application instance. Within the application security management system, a set of rules are used to determine whether to allow or disallow the request. The interceptors may work to process requests without slowing down the requests or interfering with operation of the application instance, as long as the rules are complied with.

The application security management system may receive method, function, or other data or resource access calls from the application instance via one or more interceptors, as the application instance is executed using one or more methods where calls for resource usage are designed to first pass through the application security interface. The application security interface may be the first point of contact outside the application instance for any resource usage call. The application instance may submit a call comprising a request to a resource external to the application instance via an external-facing port of the application instance. The application security interface may receive the call as if the application security interface were the intended endpoint of the request to the resource external to the application instance, after which the application security management system may process the request and determine if the external endpoint of the resource should be connected to in order to complete the request.

The application security management system may receive calls via the application security interface by detecting outgoing calls made according to a protocol of the application security interface, such as by monitoring an outgoing call list. Calls within the outgoing call list may be received by the application security management system by accessing the call while the call is still within the outgoing call list and is not yet executed. The data of the call may be accessed to analyze the call and apply one or more rules to determine whether a request of the call is valid. The call may be removed or interrupted temporarily when received by the application security management system so as to prevent the execution of a request of the call before a determination has been made on the validity of the request. The call may also be edited by the interceptor so as to effect the blocking or allowance of the request by editing the code of the call within the outgoing call list.

A request may comprise data directed to the application security interface that describes the interaction with the resource that the call requests. The data directed to the application security interface may be in a format designated by the application security interface so as to be easily understood by the application security management system. For example, the request may comprise data in an ordered list comprising an external endpoint of the requested particular resource, a characteristic of the access the application instance requests to the requested particular resource, or a use-case of the application instance's usage of the requested particular resource. An external endpoint of the requested particular resource may be an identifier for the requested particular resource such as a network address or a device ID. The external endpoint may be an identifier used to identify the resource within a system or it may be an identifier used to establish a connection or route to the resource represented by the external endpoint. A characteristic of the access the application instance requests to the requested particular resource may be any functional or qualitative data about the request such as program code to be executed by or on the requested particular resource. A use-case of the application instance's usage of the requested particular resource may be one of a set of pre-defined use-cases or may be a textual description of the intended uses of the access to the requested particular resource. The application security management system may parse the data of the request to determine information about the request necessary for validating the request.

A request may also comprise instructions for implementing the access of the requested particular resource. For example, a request may comprise program code for accessing an external hardware resource, such as a request to a driver within the device used for operating the external hardware resource. In another example, the request may also comprise an API call to an external service resource via a networked connection. In this case the request may comprise a request for access to a network hardware resource, including the network destination as an external endpoint, and the specific API call to be submitted to that network destination.

For a request that comprises instructions for implementing the access of the requested particular resource, the application security management system may parse the instructions to determine metadata that describes the request and the interactions with the resource that the call requests. The application security management system may determine an endpoint for the instruction, for example by parsing a header of the instructions for data identifying the endpoint. The application security management system may also parse the request to determine one or more instructions comprising actions for the resource to determine one or more use-cases for the request. For example, an application security management system may receive a request and parse the request to determine the request targets a microphone hardware resource as the endpoint and an instruction to direct data recorded by the microphone hardware resource to memory accessible by the application instance.

The application security management system may use the results of a determination of the endpoint of the request in determining the one or more use-cases for the request. The application security management system may, based on a determination that the endpoint is a specific hardware resource or external API resource, determine a library of instructions relevant to the determined endpoint. The application security management system may then compare the instructions of the request to the determined library to determine specific actions for the external resource. For example, an application security management system may receive a request that is targeted at an external service via API calls specific to the external service. The application security management system may parse a header to determine the instructions, which may include a network address of the external service to address API calls to. The application security management system may determine the network address to be the external endpoint, and the application security management system may retrieve data about the external service, including API documentation for the external service. The API documentation may then be used as a library to compare instructions of the received request to and determine one or more actions for the external service.

Actions determined from the request may be used as a use-case for the request or a use-case may be determined by analyzing the determined actions. A use-case may be determined by analyzing the determined actions such as by classifying the actions into one or more predefined use-cases of a set of candidate use-cases. The actions may be compared to a predefined list of possible actions, where each action is designated to relate to a given predefined use-case.

Actions may be analyzed in the context of other determined actions to determine a use-case. For example, a first determined action may be to initiate a particular data stream from a resource and a second determined action may be to record the particular data stream from the resource. The first determined action may be categorized on its own to be of a first use-case for accessing the particular data. The second determined action may be categorized on its own to be a generic use-case for recording data from the resource. The first determined action and the second determined action, when considered in the context of each other, may be determined to be of a third use-case of recording the particular data. The first and second use-cases may be of a set of permitted use-cases, however, the third use-case may be of a set of non-permitted use-cases.

### Evaluation of Requests by Application of Rules

After determining data describing information about the request, the request may be tested against one or more rules to determine an outcome for the call to the resource, such as a resource external to the application instance. The data describing information about the request may be used in determining if the request comports with one or more rules for requests. For example, the one or more rules may indicate a set of logical conditions that may evaluate to true for a request to be a valid request and the rule to be satisfied.

A rule may be a list of valid or invalid use-cases for a request. For example, an application instance that should not have access to a particular external hardware resource may have one or more pre-defined use-cases involving access of the particular external hardware resource that are labeled as invalid use-cases for requests by the application instance. A use-case may be narrowly or broadly defined as necessary to cover all possible use-cases. When the application security management system determines a particular use-case for a request, the use-case may be compared to the list of valid or invalid use-cases to determine if the particular use-case is valid. If the particular use-case is valid, then the rule is satisfied. For a list of valid use-cases, the use-case is valid if in the list and invalid if not in the list. For a list of invalid use-cases, the use-case is invalid if in the list and valid if not in the list. In one example, the list of valid or invalid use-cases includes both valid and invalid use-cases, where the list maps each possible or defined use-case as valid or invalid.

A rule may be dependent on a current state of the device and/or application. A rule may specify for a given use-case a set of logical conditions for the state of the device and/or application. The device and/or application may comprise one or more elements or resources which may be in one of a plurality of states. The state of the device and/or application may be defined as the collection of current states of the one or more elements or resources of the device and/or application. Based on the set of logical conditions for a given rule, the application security management system may access one or more elements or resources of the device and/or application to determine the current state of the one or more elements or resources. The current state of the one or more elements or resources may then be compared to the set of logical conditions for the state of the device and/or application to determine if the rule is satisfied for the given use-case.

When one or more rules are determined to be satisfied, the request may be executed. A request is executed by connecting to the endpoint, connection handle, or interface of the particular requested resource. The endpoint may be connected to by the application security interface such that the application security interface transports data exchanged between the application security management system and the application instance without interruption. The application security management system may record data exchanged between the application security management system and the application instance.

The application security management system may also submit the request to the endpoint in a connection with the resource such that the application security management system may receive a response from the resource as the intended target of the response. The application security management system may then review the data received in response from the resource and determine a subset of data to send to the application instance. The application security management system may review the data received from the resource by comparing the data to a set of rules. The set of rules may specify, for example, data that may not be passed to the application instance. The application security management system may also review the data received from the resource using analysis from, for example, a machine learning model, based on labeled feedback of valid and invalid data for use by the application. The data may be passed to the machine learning model to determine if prohibited data is included. The machine learning model may be trained on labeled data of data retrieved from a resource of a device that is manually determined to be valid or invalid for passing to an application instance with security concerns. The machine learning model may output a subset of data of the data received from the resource that is permitted to be passed to the application instance.

The one or more rules against which a request is tested may be of a set of rules. The set of rules may be one set of rules of a plurality of sets of rules where each set of rules represents a different combination of rules. A set of rules may be used as the current set of rules for testing against requests based on a condition. The condition may be dependent on an instruction from the application security management system to utilize the current set of rules. The condition may also be dependent on a current state of a user selection or setting for determining the current set of rules. Alternatively, the condition may also be dependent on one or more states of the application instance, the application security management system, or the device. The application of the conditions may be performed by an activation logic which determines a set of rules to apply based on a set of current conditions.

For example, each set of rules of a plurality of sets of rules may be associated with a region. The application security management system may detect a current region, such as by determining a current location of the device such as by requesting an IP address of the device or a GPS location of the device. The condition for the selection of the current set of rules may be dependent on the current region, such that the current set of rules is selected based at least in part on the current set of rules being associated with a current region of the device. In this way, the activation logic may enable protection for US users and disable protection for non-US users, or have different rules/logic for different regions and situations with different regulations and other constraints.

When one or more rules are determined to be satisfied, the request may be logged in a log of requests along with the one or more rules and the determination of the validity of the request. The log may record in a record of the log metadata about the request, for example, the call received, the component request of the call, the endpoint of the particular resource that the request is attempting to access, a time that the call was received, one or more current status indicators of the device, and a determination as to the validity of the request. The log may also record in a record of the log, metadata about the functionality carried out by the application instance in relation to access to the particular resource, such as the determined use-case of the request. The records of the log, or samples selected therefrom, may be manually reviewed for accuracy or for potential instances of detected invalid request.

A rule may be dependent on records within the log of historical requests or accesses. A rule may state that a request for a particular resource may be valid only if a prior historical request was made, determined to be valid, and a historical access is recorded for the same or a different resource. For example, a rule may state that a request is to a microphone resource is not valid unless the application instance has requested access to a touch screen interface resource that was determined to be valid in the time since the device was last changed to an awake state.

When a rule is determined to not be satisfied, the request may not be executed, and a response may be generated to submit to the application instance that indicates that the request was denied. The application security management system may generate a generic response to the application instance indicating the request was denied. The generic response may be a response comprising a response header and an empty response data. The response header may indicate that the data of the response is empty. The application security management system may also generate a generic response based on one or more default protocol responses. The application instance may access a list of protocol responses specific to requests made to the application security management system which may indicate one or more default rejection responses, such that the application security management system may transmit one or more of the one or more default rejection responses which may be properly interpreted by the application instance to be a rejection specific to the request made to the application security management system.

The application security management system may generate the response by accessing data about the particular resource such as documentation about the resource to determine a response specific to the particular resource. For example, the application security management system may access documentation such as driver information about a hardware resource to determine the form of a response from the hardware resource indicating an invalid request to that hardware resource. Alternatively, the application security management system may access the particular resource to request a response for an invalid query or request to the particular resource. For example, for a request to an external website the application security management system may generate and send a request to the external website to retrieve data representing an error page for accessing an invalid domain of the website such as a “404” page.

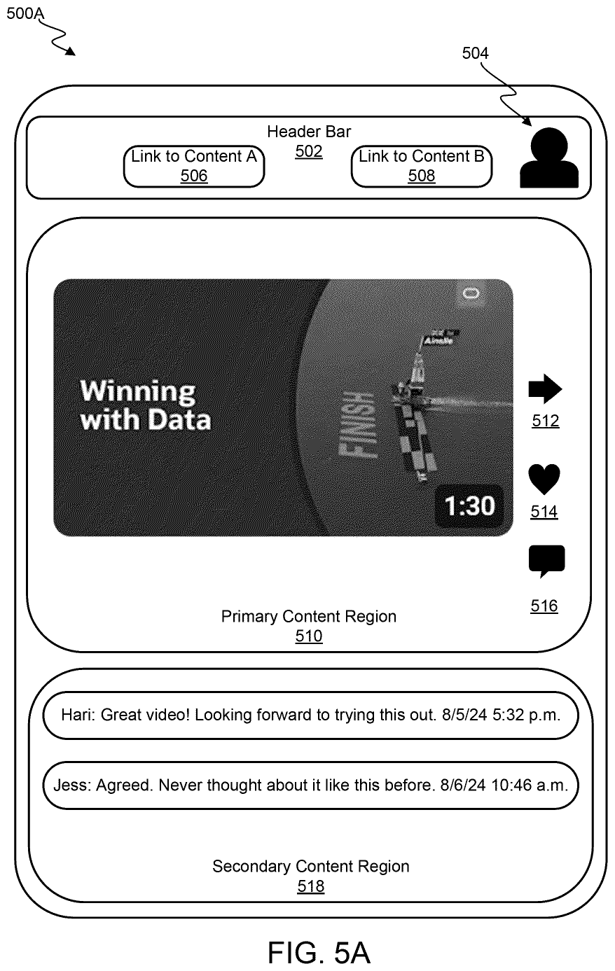

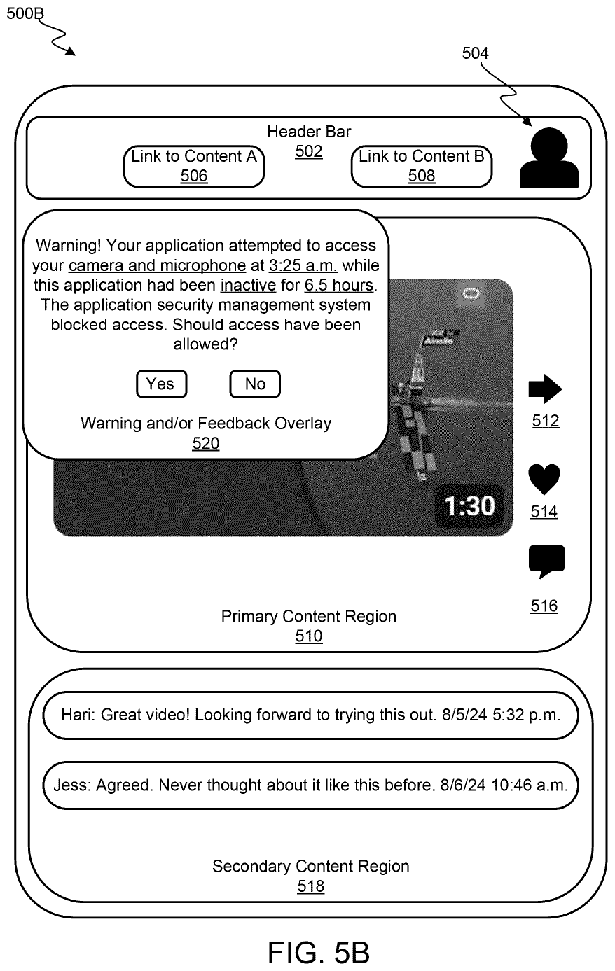

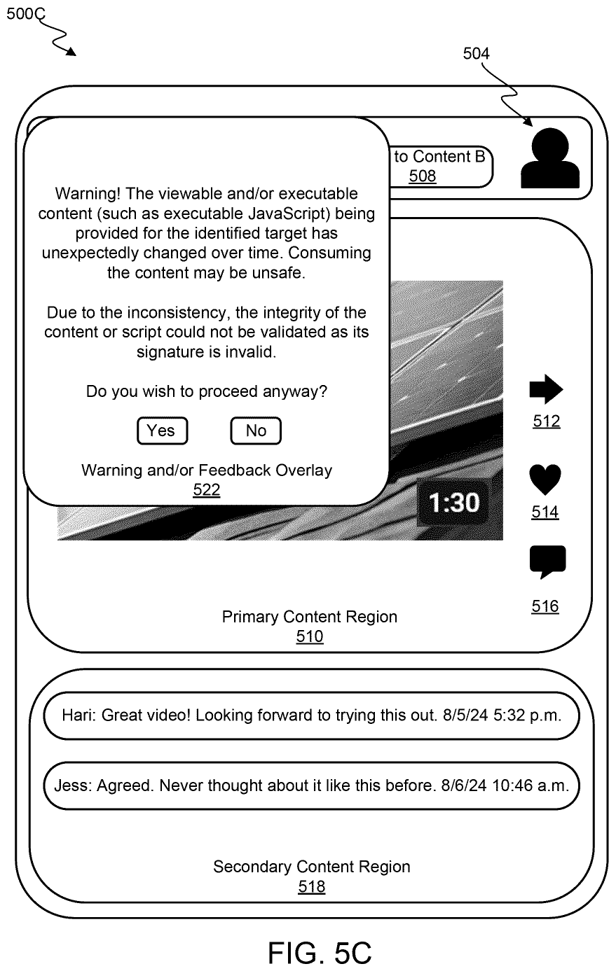

When a rule is determined to not be satisfied and a request is not valid, the request may be logged in the log of past requests with an indication that the request was determined to be invalid. When logging a request determined to be invalid, the application security management system may also generate a notification to be displayed to the user describing details of the request, such as the notification shown in in FIG. 5B.

When a rule is determined to not be satisfied and a request is not valid, the user may be notified of the request and the determination the request was not valid. A notice may be displayed to the user including the information about the request, such as the determined use-case of the request and the requested resource. The notice may be a log of requests by the application instance. The notice may be displayed immediately upon determining that the request is not valid, or it may be displayed at a later time such as when the device is next in an awake mode.

When a rule is determined to not be satisfied and a request is not valid, the user may be prompted to complete an authentication test displayed to the user to alternatively validate the request. The authentication test may be a method of confirming a user is currently using the device. The authentication test may confirm the user is currently using the device such as by a captcha request to confirm a user is currently using the device and thus the request was likely sent by the user. The authentication test may also be a method of confirming a specific user is currently using the device. For example, the authentication test may be a request to re-enter user credentials such as a password. If the authentication test is successfully passed by the device, a prior request may be re-determined to be valid. The authentication test may not be performed by a visible display, and may instead by performed by recording user input received after the request and validating the request by an authentication test on the recorded user input to determine if the user is currently using the device.

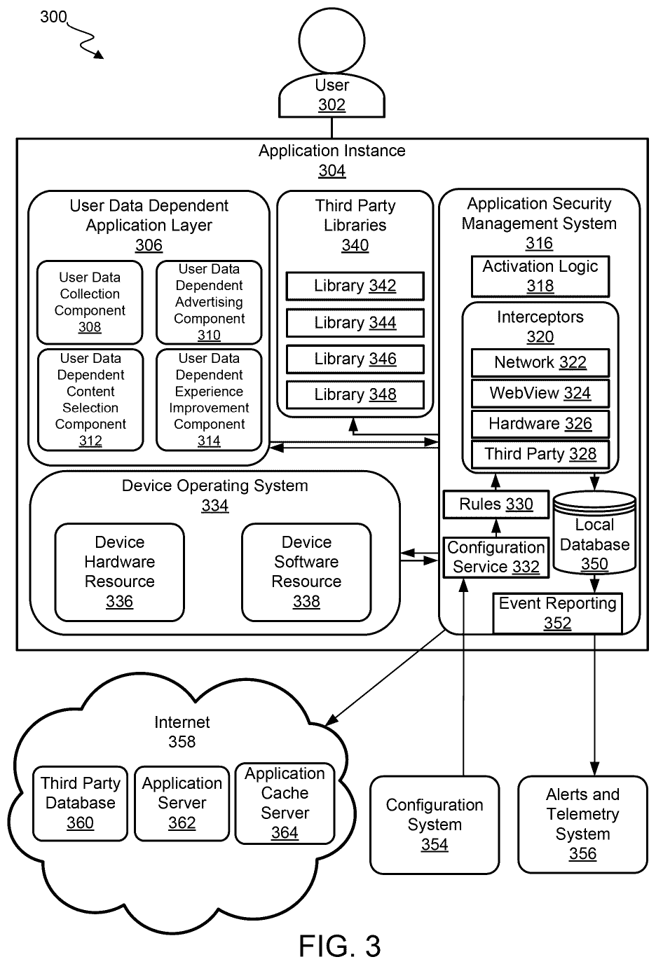

FIG. 3 depicts a system 300 for implementing application security. A user 302 accesses an application 304 for which resource access functionality is wrapped by an application security management system 316. The application instance may include a user data dependent application layer 306 which the application security management system 316 interacts with. The user data dependent application layer 306 contains a plurality of components 308-314 which manage various elements of accessing and utilizing user data within the application instance, including accessing resources external to the application instance or other certain resources. The user data dependent application layer 306 may include a user data collection component 308. The user data collection component 308 may access various resources to collect user data. The user data collection component 308 may record user data passively though instances of user data collection by other components of the user data dependent application layer 306, or it may be used as a means of connection with the application security management system 316 for collecting user data required by other components of the user data dependent application layer 306. The user data dependent application layer 306 may include a user data dependent advertising component 310. The user data dependent advertising component 310 may access user data in order to determine advertising content or for determining an advertising strategy. The user data dependent advertising component 310 may access user data related to user preferences such as data of user interactions with content. The user data dependent advertising component 310 may also access resources for retrieving advertising content to display. The user data dependent application layer 306 may include a user data dependent content selection component 312. The user data dependent content selection component may, like the user data dependent advertising component 310, access user data relating to user interactions with content. The user data dependent content selection component may also access an application server 362 to retrieve content and to transmit representations of user instances of interaction or patterns of content consumption. The user data dependent application layer 306 may also include a user data dependent experience improvement component 314. The user data dependent experience improvement component 314 may access user data relating to usage patterns of the application instance such as methods or patterns of user input or most common types of interactions. For example, the user data dependent experience improvement component 314 may record instances of user input on various menu options within the application instance. The user data dependent experience improvement component may also access an application server 326 to transmit representations of user instances of interaction with an application instance user interface or patterns of user interactions with an application instance user interface.

The application security management system 316 may wrap the application instance, such that the access of resources must be first passed through the application security management system 316. The application security management system 316 may communicate with the user data dependent application layer 306 to receive calls to resources. The application security management system 316 may include activation logic 318 that controls the activation of the application security management system 316 such that the application security management system 316 does not need to be run as a constant process but may be initiated or activated whenever the activation logic 318 detects an activation event. An activation event may be, for example, the receiving of a call from the application instance to the application security management system 316 to request access to a resource. The call is then processed by one or more interceptors 320 which determine the course of action to take with the call. The interceptors may include a network interceptor 322, a WebView interceptor 324, a hardware interceptor 326, or a third party interceptor 328. After determining a course of action for the call, the interceptors 320 may interact with the device operating system 334 to access a device hardware resource 336 or a device software resource 338 to fulfil the request of the call.

The network interceptor 322 may be used to intercept requests by the application instance to any networked endpoint external to the application instance. The application instance may submit a request to access a given network address, such as a website, or submit a request to access a network device for accessing remote network endpoints. Such network requests may be reviewed by the network interceptor 322 to determine the request, any metadata about the request such as a use-case of the request, and to compare the metadata about the request to a set of rules 330. The WebView interceptor 324 may be used to intercept accesses by the application instance to particular views of any web pages. The hardware interceptor 326 may be used to intercept requests by the application instance to any hardware resource of the device. The application instance may submit requests to access a hardware resource or program data for accessing or controlling the hardware directly. Such hardware resource requests may be reviewed by the hardware interceptor 326 to determine the request, any metadata about the request such as a use-case of the request, and to compare the metadata about the request to a set of rules 330. When determining that a request satisfies the set of rules 330 and the request is valid, the hardware interceptor 326 may submit a request to the device hardware resource 336 to fulfil the request. The third party interceptor 328 may be used to intercept requests by the application instance to any third party resource. The application instance may submit requests to access third party resources, such as a remote third party server, or may submit network requests to a third party service with included program language to interact with the third party service such as an API call. Such third party resource requests may be reviewed by the third party interceptor 328 to determine the request, any metadata about the request such as a use-case of the request, and to compare the metadata about the request to a set of rules 330. The third party interceptor 328 may access a set of third party libraries 340. The third party interceptor 328 may access a targeted library 342 of the libraries 342-348 of the set of libraries 340. The third party interceptor 328 may retrieve from the targeted library 342 a set of library definitions which may be utilized in interpreting the usage-case of the request. The third party interceptor 328 may also use the targeted library 342 for accessing a third party database 360 to satisfy a request that the third party interceptor 328 has determined to be valid.

When an interceptor of the set of interceptors 320 makes a determination on a request from the application instance, the interceptor may record the request, any metadata about the request, and the determination of the request's validity to a log within a local database 350. The new log may also trigger an event reporting service 352 which may also communicate with an alerts and telemetry system 356 which may receive logs of resource access requests from the local database 350 via the event reporting service 352. The alerts and telemetry system 356 may utilize the transmitted logs to determine new rules for the set of rules 330 or to notify security personnel of instances of invalid resource access requests.

The application security management system 316 may, via a device hardware resource 336 and/or a device software resource 338, access the Internet 358 to satisfy requests determined to be valid. Various remote network addresses may be accessed via the Internet 358, such as a third party database 360, an application server 362, or an application cache server 364. An application cache server 364 may be requested specifically by an application instance call, or it may be access instead of the application server 362 when a generic application service request is made.

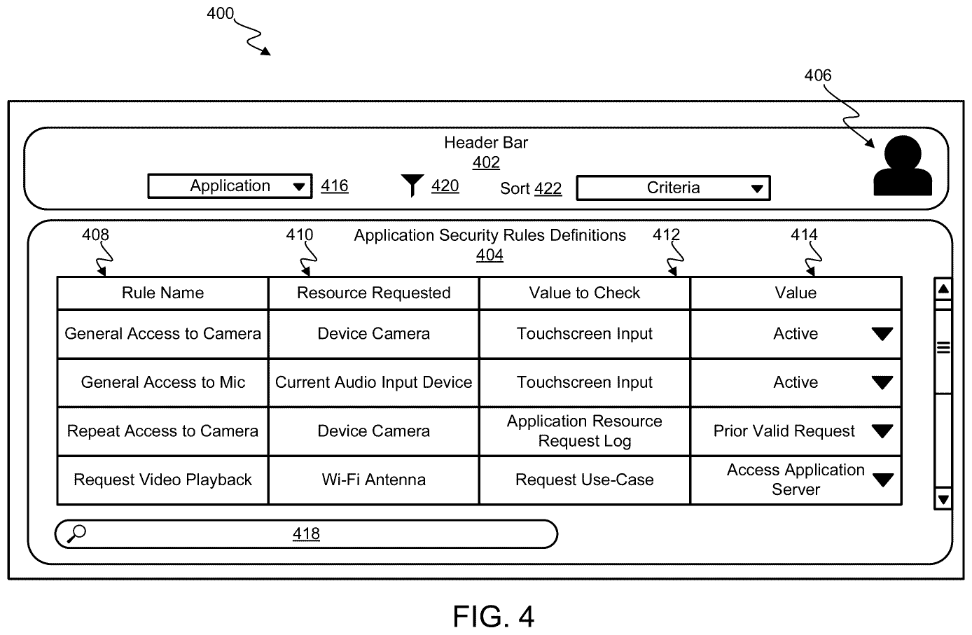

The application security management system 316 may include a set of rules 330 which dictate the conditions under which a request received by the application security management system 316 may be determined to be valid. The rules 330 may be a set of conditional statements on the use-case of the request in question, one or more status codes of a resource of the device, or a historical record of past requests of a log in a local database 350. The rules may be created and edited by the user, such as by using the user interface 400 of FIG. 4.

The rules 330 may be directed by a configuration service 332, which may direct conditions under which a rule of the rules 330 should be established or determining which rules of the set of rules 330 are currently active. The configuration service 332 may also communicate with a configuration system 354, which directs settings for the application security management system 316, such as whether the application security management system 316 should or must be used to run the application instance or to direct default rules for the set of rules 330.

A rule may be edited or newly defined by a user. A user may access a user interface for managing rules. The user interface for managing rules may display all current rules and may be populated by one or more default rules. The user interface may be a security settings interface and the user may modify the rules by selecting toggle options for one or more rules. For example, a security settings interface may include a selection for “allow microphone access in background” that when selected will toggle a rule controlling whether a request from the application instance to a microphone resource is valid depending on whether the application instance is the currently focused program or if the application instance is running in the background. The security settings interface may also include a selection for general security settings that control a plurality of rules. For example, a security settings interface may include a selection for “allow processes in background” which may toggle a plurality of rules each for a different resource that control access to the resources based on whether the application instance has submitted a request to the resources as the currently focused application or when running in the background.

Rules may also be automatically updated by the application security management system. The application security management system may transmit the log of resource access requests to a remote server for compiling instances of resource access requests from multiple user devices. The log data may be reviewed to determine updated rules for applying to future resource access requests. The logs may be sent to a security cloud provider back-end endpoints (e.g., via an alerts/telemetry service) for further analysis by security analysts, to ensure the application instance is not attempting to access or distribute data in a way that violates data security policies. The determination of new rules may be performed by the security analysts or by a machine learning model trained to output rules to prevent likely instances of improper resource access requests from log data of resource access requests. Alternatively, to avoid processing time by the application security management system, the logs may be processed using sampling by a neural network or other models to decide what traffic is sent back to the endpoints. The new rules may be transmitted to the application security management system to update the set of rules used by the application security management system. The application security management system may store the new rules and apply the new rules within the set of rules applied to future instances of resource access requests.

FIG. 4 depicts a user interface for managing application security rules 400. The user interface 400 may include a plurality of regions such as a header bar 402 and an application security rules definition region 404. The user interface 400 may recognize a user 406 via user credentials and may populate or toggle the user interface elements of the user interface 400 based on the user credentials. A region for displaying and editing rules, such as an application security rules definition region 404, may display one or more records recording rules for application security. The records may contain a domain for indicating a rule name 408, a resource requested 410, a value to check 412, and a corresponding valid value 414. A rule name 408 may be included in each record to indicate a summary of the rule for ease of navigation. The records may contain a field for indicating the resource requested 410 by the application instance that the rule will apply to. Each rule may only be triggered for a relevant request to the resource which the rule is specifically designated for. The records may contain a field for a value to check 412 which may indicate a location of a status code which should be checked to determine if a rule is satisfied. The value to check 412 may be a resource status code, a use-case of the request, and/or a value within a log of prior requests. The value to check 412 may be accessed and compared to the corresponding value 414 indicated in the record. If the value to check 412 is equivalent to the valid value 414, then the rule is determined to be satisfied, otherwise the rule is determined to not be satisfied. Input of values for domains within the record may be text-based input by the user or a limited selection of pre-defined values selected by the user from a list.

The user interface 400 may include a selection for the currently selected application 416 on which to manage rules. When selecting an application within the selection for currently selected application 416, the user interface 400, may load all saved rules for display. The user interface 400 may also include methods for navigating the rules such as a selection for searching rules 418. The selection for searching rules 418 may display rules that satisfy the search criteria entered by a user such as a name for a rule to be searched through the values of the rule value domain 408. The user interface 400 may also include a filter selection 420 for filtering the currently displayed rules. The filter selection may allow for user selection of a value of one or more domains of the rules records such as a value of the resource requested 410. The user interface 400 may also include a rules sort selection 422 for changing the order in which to display rules. The sort selection may allow for user selection of a domain of the records for determination of the sort order of the rules records. For example, the sort selection may allow a user to sort the rules records alphabetically by the resource requested domain 410 of the rules records such that all rules pertaining to a given resource are displayed consecutively.

### Validating Cached Data Sources

A request by the application instance may be made to access an application cache server. The request may be a generic network request to an application server to retrieve application data. A generic network request may be routed to an application cache server to fulfil the request, either by the application security management system or by a third-party network device. When a request is received to access an application cache server or a generic access request to an application server that may be routed to an application cache server, the application security management system may store a flag in association with the request that the request may access an application cache server. The data transmitted by an application server or an application cache server may be encrypted and thus not visible to the application security management system when conveying the data to the application instance. Alternatively, data previously retrieved by the application cache server may not be maintained by the application security management system due to constraints on resources used by the application security management system.

In order to ensure the requested data is the data retrieved from the application cache server, the application security management system may compare a representation of the data in a hash value to a prior version of the hash value. The application security management system may generate an initial hash value of the data to be retrieved from the application cache server. After determining that the request is valid, the application security management system may submit the request to the application cache server or a request to the application server which is routed to an application cache server. The application security management system may receive data transmitted by the application cache server and detect metadata of the data transmitted to determine that the data transmitted is from an application cache server. The application security management system may then generate a current hash value of the data transmitted. The application security management system may compare the initial hash value to the current hash value to determine whether the data received from the application cache server is the data expected or if the data has been modified. If the data has been modified, a rule may direct that the request is invalid and the data is not sent to the application instance.

Referring to FIGS. 5A and 5C, FIG. 5A illustrates a diagram of an example user interface 500A for a content consumption and collaboration application with data security managed by an application security management system. As shown, header bar 502 includes information about which user 504 is logged in to the application, and links 506 and 508 to various content or sets of content that are viewable in the application. Primary content region 510 includes a view of any selected or next queued content, as well as options 512, 514, and 516 to engage with the viewed content. In the example, primary content region shows a video of length 1 minute and 30 seconds. Further shown in the example, option 512 may be to send the content to another user via the application, text message, or email. Option 514 may be to engage with the content by liking or hearting the content to show positive engagement and indicate to the application that others may also enjoy viewing the content. Option 516 may be to chat with other users or type feedback or commentary about the content. For example, secondary content region 518 shows example commentary provided by other identified users along with timestamps associated with their content.

FIG. 5C illustrates a diagram of an example user interface 500C for a content consumption and collaboration application where an application security management system has blocked or delayed a display of content based on one or more rules and displayed a warning and/or feedback overlay 522 about the block or delay of the display of content. As shown, the warning and/or feedback overlay 522 states: “Warning! The viewable and/or executable content (such as executable JavaScript) being provided for the identified target has unexpectedly changed over time. Consuming the content may be unsafe. Due to the inconsistency, the integrity of the content or script could not be validated as its signature is invalid. The warning and/or feedback overlay further includes the feedback option of “Yes” or “No” to the feedback question “Do you wish to proceed anyway?, with “Yes” indicating negative feedback that the content source warning was incorrect and that the content source is more likely to be legitimate,” and “No” indicating positive feedback that the content source warning was correct and that the content source is more likely not to be legitimate. In one example, the application security management system may signature check dynamic code (e.g., JS bundles) before they are executed. In this example, the application security management system does not compare against historical samples but checks the signature (which would evidence whether the dynamic code bundle has gone through the assurance process on the server side). In various embodiments, viewable and/or executable content consumed on devices from various sources is not hashed and compared to historical content consumed on devices from various sources, and content-specific recommendations might not be enabled in such embodiments.

The underlined portions of the warning and/or feedback overlay 522 include summaries of the viewable and/or executable content being provided as compared to the content historically associated with the target. Content for high-frequency targets, such as popular videos or posts, may be summarized using generative artificial intelligence by prompting a large language model with a prompt to summarize the content and attaching the content to the prompt. Similarly, frequently used JavaScript scripts may be summarized by attaching the JavaScript content to a prompt. If the scripts change, different summaries may apply to content delivered at different times. The prompt may direct the large language model to generate a summary that complies with character length restrictions such that the summary will fit into a short warning and/or feedback overlay 522 on user interface 500C. A resulting summary may be stored in association with the content target identifier or address and/or a hash of the content itself, to avoid causing the application security management system to store large volumes of digital content in their entirety but still allowing the application security management system to provide valuable guidance on the digital content as shown in FIG. 5C. In various other implementations and embodiments, summaries of viewable and/or executable content delivered from sources are not generated, but a warning is provided without such a summary. The warning still indicates an inconsistency without exposing information about the history of content provided from the source. Different implementations may be applicable in different scenarios.

The application security management system may dynamically download and utilize cache bundles to supplement WebViews. The application security management system may verify the authenticity of these bundles to protect users from certain regions, such as U.S. users, against potential harmful content. Caches are stored by the applications to speed up user experience. Some sites, hosted at remote network resources, may be accessed frequently, and the contents may be stored in cache that does not need to be refreshed. The application instance may contain logic that maliciously changes data to modify images in the cache with propaganda and see incorrect images from the web site. The cache may be signed with keys by the application security management system to avoid the application instance tinkering with the cache, and the application security management system may verify with the key that the cache being used is the correct cache that was downloaded. Unsigned or non-validated caches should not be shown to the user and can be blocked by the application security management system. Alternatively, the user may be notified of the mismatch and given an option to view the content anyway, as shown in FIG. 5C.

### Validating Content Distribution Networks

An application instance's request may be to a content distribution network (CDN) or other target. The application security management system may determine if the CDN(s) or other targets being connected to by the request are the intended CDN(s) or other targets under the circumstances. The application security management system may check whether the request is connecting to CDNs or other targets within a whitelist of CDNs or other targets for security and if so, may allow the connection request. The application security management system may also check whether the request is connecting to CDNs or other targets within a blacklist of CDNs or other targets for security and if so, may not allow the connection request.

The CDNs or other targets may be third party content provider(s). The application security management system may store a list of known content providers as CDNs or targets accessible via CDNs, and the list may contain information relating to the access paths of those known content providers. The list may be, for example, based on a list of known, reviewed, and approved requests to the known content providers and/or responses from the known content providers. The reviewed requests and/or responses, or a signature or hash of the reviewed requests or responses, may be compared to a request from the application instance or response to the application instance in order to determine if the request or the response is valid or consistent with previously checked requests or responses.

The application instance's request to a CDN or other target may be checked by an interceptor to determine if any executable code involved in sending the request or receiving a response, such as JavaScript code, is of a type or signature expected for the target. A trusted CDN or other trusted target may receive executable code from an untrusted service, which may then be transmitted by the trusted CDN or other trusted target as part of a response to a request as a result of a security breach for the otherwise trusted CDN or other trusted target. The application security management system may determine whether the executable code from the source is the same as executable code that has already been reviewed from that source. When submitting requests for content to support the application instance, the request by the application instance or a web site implementing the application instance may be configured so as to require the inclusion of a content security header for completing requests. A trusted CDN may require the content security header when contributing to application functionality, and the content security header may restrict the web site or application instance to only loading executable code from trusted sources that are known to include executable code of an expected type or signature.

In one embodiment, the application security management system may verify whether viewed videos or executable content hosted on CDNs or listed targets are correct or not, and/or verify whether CDN or listed target is the correct CDN (matches a trusted target). The application security management system may be used to authenticate connectivity to the CDN or other target, such as verifying that the connection is made according to an allowed list.

### Tracking Application Status History for Requests

In various embodiments, a history of requests and metadata associated with requests, such as application statuses at the time of the requests, may be logged in one or more resource access logs. The resource access logs or a sampling thereof may be made accessible to a software assurance system. The software assurance system may analyze the logs or a sampling thereof to detect anomalies, infrequent patterns of resource access, or patterns of resource access that may lead to use or exposure of data without a reasonably justifiable use case.

The software assurance system may include a cloud infrastructure for authenticating software assurance users, storage of software assurance datasets, samples of logs and metadata for analysis, machine learning models trained on the samples of logs and metadata for automatically learning patterns, and manual analysis and labeling of the logs and metadata as accessing resources with a legitimate purpose, accessing resources with an unknown purpose, or accessing resources with a malicious purpose or where no possible legitimate purpose exists.

Supervised machine learning models may be trained with the labels to detect logs and metadata where resources are accessed with a malicious purpose, and the logs may be sampled from various instances of the application across different users and different devices based on a result of learning which access requests are most likely accesses with a malicious or unknown purpose.

Unsupervised machine learning models may be trained to detect anomalous or uncommon access patterns where resources may be accessed with an unknown purpose, and the logs may be sampled from various instances of the application across different users and different devices based on a result of learning which access requests are most likely accesses with a malicious or unknown purpose.

Rules on the application security management systems of the devices may be updated based on a result of learning, to prioritize blocking certain patterns of access requests that have a questionable or malicious purpose and to prioritize optimum access pathways for access requests that are known to have legitimate purposes. For example, an application that is in a state associated with a legitimate purpose may temporarily operate without resource access validation checks, unencumbering the most used resource access pathways by the application that are associated with the most common parts of the beneficially extended application functionality. Conversely, an application that is in a state that may be associated with an unknown or malicious purpose may operate with resource access validation checks in place so that more complex rules and analysis may be performed synchronously before allowing resource access to be granted in these scenarios.

### Identifying Potentially Malicious Sensor Data Use Patterns

An application security management system is provided to prevent applications from tapping into a mobile device's camera, microphone, location sensor, data repository storing sensitive data, network access resource, or other sensor, for the illegitimate purpose of disclosing recorded information to third parties in ways that are otherwise undetectable by a user of the mobile device. In one embodiment, the application security management system is implemented as a sandbox or wrapper on the application to intercept requests to use sensor data of the device. The intercepted requests may be synchronously and/or asynchronously analyzed to determine if the requests comply with security policies or attempts to expose user data or breach user privacy expectations. For example, analysis of the requests may take into account a state of the application on the device (e.g., foreground, background, foreground for t seconds immediately before and up to the access, background for t seconds immediately before and up to the access, foreground using application interface A of the application, foreground using application interface B of the application, foreground using application interface C of the application, foreground after using application interface D of another application, other foreground states or background states, and/or any sequential pattern or combination thereof) to determine whether sensor data requests and usage are practical for the given use case. In a particular example, calls to the camera, microphone, location sensor, data repository storing sensitive data, and/or network access resource that occur while the application is in the background or that are part of a set of repeated or intermittent calls to the camera, microphone, location sensor, data repository storing sensitive data, and/or network access resource at frequent intervals while the application is in the foreground may qualify as inappropriate requests, as application functionality is not typically being requested by the user when the application is in the background or intermittently at predictably timed or at high enough frequency of intervals throughout the day.

Additionally or alternatively, requests may be logged for further processing synchronously or asynchronously. The application security management system may apply rules for in-band synchronous analysis and allowance or rejection of in-flight requests, and the application security management system may also include logic for sampling and using artificial intelligence to determine what traffic should be sent to endpoints for further asynchronous out-of-band analysis, for example, via a remote software assurance system. The application security management system may receive feedback from the remote software assurance system to learn, by applying labels to a supervised model, which requests were useful for sampling purposes, for example, based on which requests were most likely to be unauthorized uses of sensors by the application.

Within the application security management system, a set of rules are used to determine whether to allow or disallow the request for resource access. Further, logging is performed to log the attempt and/or the decision on the attempt. The logs are sent to the cloud provider back-end endpoints (e.g., via an alerts/telemetry service) and/or a remote assurance system for further asynchronous out-of-band analysis by security analysts, to ensure the application is not attempting to access or distribute data in a way that violates data security policies. When sending back the requests to the endpoints, the requests might not be indiscrimately or unqualifiedly streaming back to the endpoints, costing processing time and network access resources by the application, but instead may be processed using sampling, a neural network or other models, to decide what traffic is sent back to the endpoints. For example, logs and metadata of access requests more likely to be labeled as unknown or malicious may be given higher priority in sampling than logs and metadata of access requests more likely to be labeled as legitimate access requests.

FIG. 1C illustrates a flow chart of an example process 100C that controls an application's access to sensors based on application status and/or other metadata. Process 100C starts in block 102C, where an application security management system accesses a request by an application instance on a device for a given instance of access to an audio, image, location, sensitive data, or network access resource of the device. The request is made to an application security management interface that controls access to the audio, image, location, sensitive data, or network access resource based on stored rules. In block 104C, the application security management system determines metadata associated with the request. The metadata indicates which state of candidate states the application instance is in at a time of the request and/or past states of the application instance prior to the request. Based at least in part on the given application state or states, and at least one of the stored rules, in block 106C, the application security management system determines whether to grant the given instance of access. At least one of the rules may be based on a pattern that is satisfied by the given application state or states. In block 108C, the application security management system determines whether to grant or deny access. If access is granted, in block 110C, a connection is established between the application instance and the audio, image, location, sensitive data, or network access resource. On the other hand, in block 112C, the application security management system may deny access to the audio, image, location, sensitive data, or network access resource based at least in part on a pattern that satisfies the one or more stored rules. Whether or not access is granted or denied, the application security management system may log the request and the metadata to a resource access log in block 114C. A determination is made as to whether there are any more requests in block 116C. If so, process 100C proceeds to block 102C for the next request. If not, process 100C ends.

In one example, a pattern of access requests may be satisfied based at least in part on one or more past resource access attempts listed in the resource access log. In a particular example, the one or more past resource access attempts may indicate a pattern of positive or active resource usage specific to the user for which the application security management system has learned or adapted to detect as likely occurring due to user activity or otherwise legitimate. In another example, the one or more past resource access attempts may indicate a pattern of negative, inactive, or intermittent resource usage for which the application security management system has learned or adapted to detect as unlikely occurring due to user activity or otherwise illegitimate.

The pattern may be satisfied by a variety of states of the application, such as foreground, background, foreground for t seconds immediately before and up to the access, background for t seconds immediately before and up to the access, foreground using application interface A of the application, foreground using application interface B of the application, foreground using application interface C of the application, foreground after using application interface D of another application, other foreground states or background states, and/or any sequential pattern or combination thereof.

The pattern may additionally or alternatively be based on a frequency by which access to the resource is requested, such as every hour, every 3 hours, or every day at the same time. Applications may be used legitimately by users with a regular frequency, but ordinary human delays often prevent a rigid adherence to a strict minute-by-minute routine. The closer the resource access pattern adheres to a strict minute-by-minute or even second-by-second routine, the more likely the pattern might be categorized as unknown or non-legitimate use. These patterns may be detected by a machine learning or other statistical model on device that accesses the resource access logs looking for recurrence, by a machine learning or other statistical model in a remote software assurance system, and/or by expert review of sampled logs in the remote software assurance system.

The pattern may additionally or alternatively be based on how long the application remains in the particular state after access to the resource has been granted in the past. In other words, the pattern may detect or distinguish intermittent or periodic but short-term access from stable, extended, or engaged access. For example, the intermittent access may occur to wake up the application to the foreground for the purpose of accessing the camera, microphone, location sensor, data repository storing sensitive data, and/or network access resource. In a particular example, such wake events may occur despite operating system level protections as a result of notifications or other events that result in incidental selection of the application to the foreground. Even with such incidental selection, camera, microphone, location sensor, data repository storing sensitive data, and/or network resource access would not be expected for legitimate use cases. In this example, the application security management system detects a pattern of intermittent access that co-occurs with camera, microphone, location sensor, data repository storing sensitive data, and/or network resource access and marks the pattern as likely requiring further review. The pattern may be blocked until further review in the remote software assurance system or allowed until such further review indicates that blocking is required.

In a particular embodiment, the pattern is based on a ratio between the frequency of access and a length of time the application remains in a given state after access to the audio, image, location, sensitive data, and/or network access resource has been granted in the past. For example, highly frequent access may be more likely to be legitimate access if the highly frequent access is paired with extended engagement in the application. In this scenario, the user frequently uses the application presumably for the application's intended purpose. Similarly, short periods of engagement may be more likely to be legitimate access if the short periods of engagement are paired with infrequent access. In this scenario, the user rarely uses the application for the application's intended purpose and is unengaged when using the application. A ratio that may trigger further investigation and/or resource access blocking is highly frequent access paired with short engagement, leading to a very high ratio between frequency of access and the length of time the application remains in an active state. This access may be marked as unknown or illegitimate access, and such marking may further be based on the precision of the predictability of the period of time between access requests, where legitimate human access is often less precisely predictable.

In various embodiments, a request may be received by the application security management system via an application security interface. The application security interface may be implemented as a type 1 or a type 2 hypervisor or other virtual machine that manages access to resources such as camera(s), microphone(s), location sensor(s), data repository storing sensitive data, and/or network resource(s). A type 1 hypervisor may be built into the device to manage direct access to the resources. A type 2 hypervisor may be installed on the operating system or platform to manage operating system or platform calls to the resources. A virtual machine may exist at any layer between the application and resource to virtualize access to the resource through the application security interface, where the application makes calls either to the application security interface (for example, via an exposed API for application security purposes) or intercepted by the application security interface (for example, via an exposed API for resource access purposes for which the application security management system injects application security functionality). The application security management system may also exist as an independent library for which calls to access resources are supported whether or not the application security management system encloses the application in a sandbox or other virtual environment. In this example, the application may call the application security interface to access resources, and the application may be audited to ensure that calls to access the resources are passing through the application security interface and not being made directly to the operating system or other interface that may also exist for accessing resources.

In one embodiment, the application security interface may receive a binary object from an application, via an application security interface API call, as a virtual resource handle, or as intercepted from a resource interface API call. The binary object may be parsed to extract a request identifier from the binary object. The request identifier may identify the type of resource being requested, for example. The binary object may also contain metadata such as the use case for which the resource is requested (e.g., indicated by a data flow identifier), the state of the application when the request is being made, past states of the application, a security classification of the user (where different users have different security classifications and may be treated according to different rules), or other information about the user, the application session, and/or the device state. For example, the application state may be determined by extracting an application state identifier from the binary object. Other information may be similarly encoded into the binary object or otherwise determined from the application in response to the request. The request may be handled according to the request identifier, application state identifier, and/or any other information extracted from the request, to determine whether the resource access request is allowed or denied.

In one embodiment, resource access requests may be fast-tracked for resource access when the requests are associated with application states that are common for that type of resource access request. The fast-tracking may involve avoiding a further check of historical application states or other current or historical metadata about the user, the application session, and/or the device state. The fast-tracked resource access may be unencumbered by the additional checks that may take place when such common pairings of resource access request type and application state are not present in the request. Fast-tracking a resource access request may involve checking a threshold condition, and, if the threshold condition is satisfied, avoiding further checks based on the user, the application session, and/or the device state. Such avoided further checks may have involved parsing the resource access logs for a more complex analysis, which would encumber resource access by the application for the purpose of increased application security. If the threshold condition is not satisfied, such further checks may be performed.

As shown in FIG. 3, the interceptors perform checks on requests for sensor data, and the rules specific to application status on the device would be applied to determine whether the requests are allowed or disallowed. Expert analysis of the logs may feed back into the configuration service for reconfiguring the rules to discover different patterns that are likely to result in inappropriate use of on-device sensor data.

Applications secured using the application security management system described herein may have higher levels of trust and security than applications not secured using the application security management system. Devices secured with the application security management system may also have higher levels of trust and security than devices not secured with the application security management system. End users and government users may be particularly interested in using this technology to prevent inappropriate and unauthorized use of on-device microphone, camera, location sensor, data repository storing sensitive data, and/or network access data by the applications, and such users with higher security risks may be treated by the application security management system according to a different set of rules than other users of the application without the higher security risks.

In one embodiment, an application security management system processes requests for a production application using rules that analyze the requests to determine if the requests violate data security policies based on a state of the application at or around the time of request (e.g., foreground, background, foreground for t seconds immediately before and up to the access, background for t seconds immediately before and up to the access, foreground using application interface A of the application, foreground using application interface B of the application, foreground using application interface C of the application, foreground after using application interface D of another application, other foreground states or background states, and/or any sequential pattern or combination thereof), such as data security policies relating to microphone, camera, location sensor, data repository storing sensitive data, and/or network access resource usage. The application security management system may also provide live updates to the resource access rules based on findings of security analysts that, on a slower (optionally asynchronous) track of more thorough review, investigate logs of requests that feed into the application security management system.

In various embodiments, applications may request to access device sensors such as a microphone, camera, location sensor, data repository storing sensitive data, and/or network access resource. Based on a data flow identifier, the application security management system may determine that the microphone, camera, location sensor, data repository storing sensitive data, and/or network access resource is being accessed on behalf of the application for a particular use case. The application security management system may check that there is a proper or valid use case for accessing resources such as the microphone, camera, location sensor, data repository storing sensitive data, and/or network access resource to prevent the application from spying on or spoofing information about the device user. For example, a social media application, such as one for generating and/or consuming audio, image, location, sensitive data, network traffic, video, and/or textual content from users, may access a microphone, camera, location sensor, data repository storing sensitive data, or network access resource for legitimate purposes according to proper or valid use cases identified by data flow identifiers and according to use cases that have been flagged as improper or invalid use cases that are identified by data flow identifiers corresponding to different usage patterns. For example, data flow identifiers corresponding to background application operation may be flagged as invalid use cases for accessing the camera, microphone, location sensor, data repository storing sensitive data, and/or network access resource.

In one embodiment, the microphone, camera, location sensor, data repository storing sensitive data, and/or network resource accesses may be detected based on the use cases provided to the application security interface when data from the microphone, camera, location sensor, data repository storing sensitive data, and/or network traffic information is requested. The use cases may be identified using the data flow identifier corresponding to why the microphone, camera, location sensor, data repository storing sensitive data, and/or network resource access is requested. The data flow identifier may be audited through testing or code assurance to see that accesses to the microphone, camera, location sensor, data repository storing sensitive data, and/or network resource during testing are done with a properly identified data flow that corresponds to the actual use case. In addition to auditing the data flow identifier through testing, the data flow identifier may be audited based on other metrics that are collected from the application. For example, an amount of time a user is active on the application's interface may be measured and provided to the application security interface, and auditing may be done to verify that the amounts of time reported are consistent with actual amounts of time spent on the application's interface.

In this manner, the application security interface may serve as a wrapper to resources such as the microphone, camera, location sensor, data repository storing sensitive data, and/or network resource, and the wrapper may be audited for effectiveness by testing the wrapper to ensure the use cases and/or metrics are being properly identified and reported by or collected from the application in practice. For example, auditing may reveal whether foreground resource accesses (e.g., when the application is maximized or otherwise visible on the device's screen for application operation more than just as an operating system level notification) during active application use are being properly identified and distinguished from background resource accesses (e.g., when the application is minimized or not visible on the device's screen or presented merely as an operating system level notification) during background application use.

In one embodiment, the foreground and background accesses may be logged through the application security management system whether or not resource access is requested, and the foreground and background access logs may be checked against test usage of the application and actual foreground and background tasks performed during the test usage. If the application accurately reports foreground and background activity, the application security management system may determine whether the accurate foreground and background activity is consistent with different historical patterns of resource access for sensors such as the microphone, camera, location sensor, data repository storing sensitive data, and/or network resource. In a particular example, the historical patterns may indicate that camera access is anomalous, rare, or never occurs when the application is running in the background, and, as such, camera access in the background may be flagged as anomalous activity if such activity is detected in the future.

By pairing sensor access (e.g., camera, microphone, location sensor, data repository storing sensitive data, and/or network resource access) requests with a state of the application at the time of sensor access, the application security management system may determine what types of resource accesses in different application states are common and flag uncommon pairings of resource accesses and application states for expert review or for additional user review via a prompt, for example. The additional review may confirm the resource access is valid or reject the resource access. A rejection may trigger further review by an expert as to how the resource access request occurred at all if not allowed by the user. For example, the expert may review a log of application activity, application states, resource requests, and/or user responses to resource access prompts to determine which application modes require further investigation and attempt to replicate the rejected request.

The pairs or tuples of sensor access requests with application states may also be used to automatically confirm that some resource access requests are allowed. For example, if a user is active on a particular interface of an application, such as a video sharing interface, and the application requests access to the camera, microphone, location sensor, data repository storing sensitive data, and/or network resource, such access request may be detected as common and non-anomalous, and automatically allowed by the application security management system based on historical activity or rules.

The tuples of sensor access requests and application states may indicate that some access patterns are non-anomalous for some users but anomalous for other users. For example, some users may access the application quickly to post content quickly with a camera, microphone, location sensor, data repository storing sensitive data, and/or network resource access just before the application is immediately closed. Other users may keep the application open for a longer period of time before accessing the camera, microphone, location sensor, data repository storing sensitive data, and/or network resource to post content. In this manner, the application security management system may detect user-specific patterns that are valid or not and flag as potentially anomalous patterns that do not match user-specific expectations based on historical activity associated with a specific user.

In one embodiment, the application security management system may store local profiles of different user types on the device and detect or determine which user type a current user most likely corresponds to based on the user's historical activity. Anomalous resource request activity may then be detected based on the user type to which the user most likely corresponds as well as the user's ongoing resource request activity and application usage activity. The application security management system may also periodically update user types based on updated historical activity as usage patterns in the application change over time.

The application security management system may also account for information that is anomalous regardless of the user. For example, some activity, such as camera, microphone, location sensor, data repository storing sensitive data, and/or network resource access while the application is in the background, may be anomalous regardless of the user and regardless of whether a small percentage of users have approved such access requests in the past, if a large percentage of users have rejected such access requests in the past. In this manner, some anomalies may span across many or even all user types, and such anomalies may trigger further review or blocked resource access, depending on the rules.

As another example, the tuples of sensor access requests and application states may indicate that an application is intermittently in an active or otherwise valid state during resource access requests. Although an initial resource access request may be granted due to the active or otherwise valid application state at the time of the request, a subsequent resource access request may be rejected when the intermittent activation of the application is detected. In a particular example, the application security management system may detect that the application becomes active for less than a second once every few minutes to request access to a camera, microphone, location sensor, data repository storing sensitive data, and/or network resource once every few minutes. The access request may or may not extend access to the resource beyond the intermittent activity when the device becomes inactive. The application security management system may detect this pattern of resource access requests and reject requests when the application has been active or otherwise in a valid state for less than a threshold amount of time. Additionally or alternatively, the application security management system may notify the user that such access requests are occurring and the pattern of occurrence, including, for example, timestamps and application states and/or resources requested at a time indicated by the timestamps.

In an alternative embodiment, the application security management system pulls metrics about foreground and/or background activity from the application and/or device and compares the pulled metrics to the reported resource requests by the application during an auditing phase to ensure that the application is requesting resource access through the application security management system's application security interface. If the application is bypassing the application security management system's application security interface to access resources, such activity may be flagged during auditing or code assurance to indicate a correction in the application code is needed to utilize the application security interface. The application code may then be corrected to properly use the application security interface to access resources such as the camera, microphone, location sensor, data repository storing sensitive data, and/or network resource. For example, such correction may be required to uphold a service agreement between the application security management system provider, the application provider, and/or other interested third parties such as regulatory entities.

In various embodiments, the application security management system may track resource access requests across different application instances for different users over time to determine which patterns of resource access normally occur during application usage and which patterns of resource access do not normally occur during application usage. The abnormal patterns may be flagged as anomalies that may be further investigated.

Access to the resources may be disabled until the anomalies are investigated and resolved or not resolved to clarify that the resource access is legitimate. In one embodiment, anomalous access patterns trigger a preventative process for notifying the user that resource data, such as camera, microphone, location sensor, data repository storing sensitive data, and/or network resource data, is being collected or is being requested to be collected. Based on the notification, the user may approve the additional access or reject the additional access. Even if the notification occurred when the device was inactive or the application was in a background state, the resource access may be delayed until the notification receives prompted user feedback. The prompted user feedback may cause access to be allowed or rejected, depending on whether the user confirms or rejects that a particular resource access was needed to carry out a recent operation. The notification may have a timestamp, a state of the application, an application-identified use case, and/or other information displayed to the user to provide context on what access was requested, when, and potentially why.

Referring to FIGS. 5A-5B, FIG. 5A illustrates a diagram of an example user interface 500A for a content consumption and collaboration application with data security managed by an application security management system. As shown, header bar 502 includes information about which user 504 is logged in to the application, and links 506 and 508 to various content or sets of content that are viewable in the application. Primary content region 510 includes a view of any selected or next queued content, as well as options 512, 514, and 516 to engage with the viewed content. In the example, primary content region shows a video of length 1 minute and 30 seconds. Further shown in the example, option 512 may be to send the content to another user via the application, text message, or email. Option 514 may be to engage with the content by liking or hearting the content to show positive engagement and indicate to the application that others may also enjoy viewing the content. Option 516 may be to chat with other users or type feedback or commentary about the content. For example, secondary content region 518 shows example commentary provided by other identified users along with timestamps associated with their content.

FIG. 5B illustrates a diagram of an example user interface 500B for a content consumption and collaboration application where an application security management system has blocked or delayed a resource access request based on one or more rules and displayed a warning and/or feedback overlay 520 about the block or delay of the resource access. As shown, the warning and/or feedback overlay 520 says: “Warning! Your application attempted to access your camera and microphone at 3:25 a.m. while this application had been inactive for 6.5 hours. The application security management system blocked access. Should access have been allowed?” Feedback options are provided as “Yes,” indicating negative feedback or that the blocking was inappropriate, or “No” indicating positive feedback or that the blocking was appropriate but the access request was not legitimate.

As shown, example variables in the warning and/or feedback overlay 520 are underlined and may be substituted for any values of the variables relevant to the blocking that occurred. For example, “camera and microphone” may correspond to a placeholder variable, % resources, that identifies any resources for which access was requested and blocked. 3:25 a.m. may correspond to a variable, % time, that identifies a time at which the resource access was requested. The value “inactive” may correspond to a variable, % applicationstate, that identifies a state of the application at that time, and the value “6.5 hours” may correspond to a variable, % timeinstate, that identifies how long the application as in the identified state leading up to the resource request.

In various embodiments, in addition to metadata about application and device usage, metadata may be gathered from the device and/or application about the user to indicate a level of security to be applied to the user. For example, a country of the user may be determined based on the SIM card country code, an IP address of the device, a mobile country code of the carrier network, a system region configured on the device, and/or an app region as selected by a user on the device. Different security settings may be applied by the application security management system for users in different regions, and, for some regions, the application security management system may not apply any additional application security settings beyond those already applied by the application itself. Certain users such as government workers with security clearance, may be given a higher level of security using a different set of rules by the application security management system than the rules applied to resource requests for other users.

### Integrating an Application Security Management System with an Application

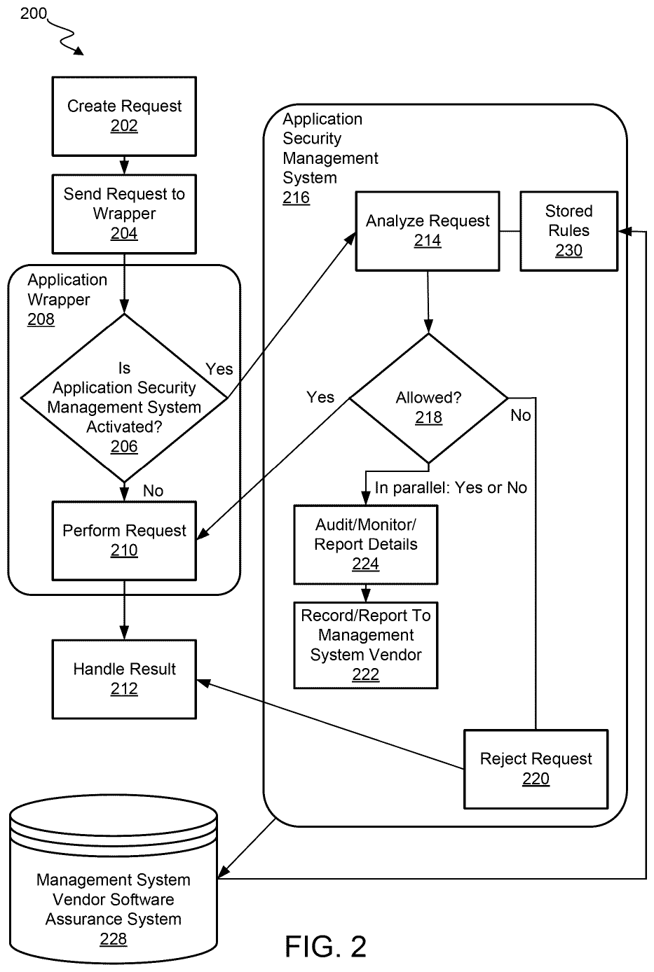

FIG. 2 shows an example of an integrated process between the sandbox and the application. As shown, a request is created in block 202, and the request is sent to a wrapper or intercepted by a wrapper in block 204. Application wrapper 208 then determines, in block 206, whether the application security management system is activated for the request. If not, in block 210, the request is performed, and, in block 212, the result is handled by the application. For example, the result may be a connection handle for the requested resource that the application may use to obtain information from the resource or otherwise control the resource.

If the application security management system is activated, application security management system 216 analyzes the request in block 214 in accordance with stored rules 230 and determines whether the request is allowed or not in block 218. If not allowed, the request is rejected in block 220. In parallel, whether the decision in block 218 is Yes or No, the application security management system 216 may audit, monitor, and/or report details about the request and/or decision. The details may be recorded or reported to management system vendor in block 222. Management system Vendor Software Assurance System 228 may access the reported details about requests and/or decisions made by the application security management system and update stored rules 230 if different decisions are desired for future resource access requests.

The application vendor may identify functionality in the application whereby protected data may exit the device (through any mechanism), and the application security management system vendor may verify that the data is exiting the device using audited pathways to ensure that protected data is not exiting the device in an unauthorized manner. The application vendor may restructure the application to use an application security interface to access resources rather than directly accessing resources, to ensure such access may be audited by the application security management system. The application security management system evaluates resource access requests through the application security interface and determines whether to allow or reject the requests. Whether allowed or rejected, the requests may be logged to the application security management system.

Application security management system initialization is the loading and startup of the application security management system and application security interface(s) within the application. This happens at application launch, regardless of any other criteria. The launch of the application will load the application security management system to perform application security management functionality. Activation of the application security management system is the enablement of auditing, monitoring, and protections provided by the application security management system. The application security management system may be activated in application instances for each user that satisfies certain criteria. Deactivation of the application security management system is the disablement of the protections provided by the application security management system, and deactivation occurs for an application instance when user(s) of the application instance no longer satisfy the certain criteria. The application may be responsible for accurately activating and deactivating the application security management system when appropriate, and a vendor of the application security management system may audit enablement and disablement behavior through code inspection and testing fleet deployments, and may provide real-time reporting to detect anomalies using the application security management system. Application security management system activation and/or deactivation may occur upon initial application installation, account creation, or sign-in/sign-out from an account, depending on whether the user satisfies the certain criteria.

In one embodiment, mobile application code is modified to include application security management system binary or obfuscated code, and the obfuscated code is integrated into the application by calling application security interfaces provided by the application security management system. The interfaces may include library calls that can be made by the application to access resources, and the resource access requests via the application security interface may be audited or monitored according to the obfuscated binary code of the application security management system.

The application vendor may provide a binary of an integrated application for testing purposes and code assurances, to ensure that the application security interface is being used to access resources and to ensure that resources are not being accessed outside of the application security interface. For example, the code assurance process may test certain application functionality to ensure the functionality is passing the correct agreed-upon resource access request data into the application security interface. Once the integrated application has passed code assurance, the integrated application may be published by the application security management vendor and/or the application vendor, verified by the other of the application security management vendor or the application vendor, to customers for use by end-users, for example, through an app store such as one offered by Apple (iOS) or Alphabet (Android). The application security management system may then be enabled for end-users that satisfy certain criteria.

The application security management system code may be obfuscated by the application security management system vendor before integration with the application code, and the integrated application code may be further obfuscated by the application vendor after integration and before validation by the application security management system vendor. This two-pass obfuscation allows the code to be passed back and forth between the application vendor and the application security management system vendor without revealing underlying source code of either the application security management system or the application.

### Opaque Binary Library for Communication Monitoring

In various embodiments, an application security management system is provided to prevent applications from exposing sensitive user data to third parties in ways that are undetectable by the users. Applications do not have a good track record of self-reporting privacy violations, and the application security management system looks for data access patterns that indicate a higher likelihood of privacy violations so these data access patterns can be blocked and/or exposed to the user or security experts for auditing the application.

In one embodiment, a rules engine, OrbuCode, applies the rules for requests being processed by the sandbox. The rules engine uses bytecode instructions to apply and interpret the rules. The bytecode-based library may be used to monitor communications being transmitted from a mobile application. The library is implemented to detect whether the application is attempting to send an outgoing communication, such as by executing an instruction to make a call directly to a resource or a virtual representation of the resource, or by directly communicating with an API of the application security management system. If a resource access request is detected, information is logged, and the application security management system determines whether to permit or reject such a communication.

When an application vendor or assurances provider generates a build, the application security management system provider may provide a binary of the library, which is integrated into the application in the build system. The application vendor may send the application security management system vendor an integrated app that includes calls to the library. Then application security management system vendor then runs assurance checks (which may be static checks or dynamic checks) to see if the application security management system is appropriately integrated with the application (e.g., to detect resource requests when calls are made).

FIG. 1B illustrates a flow chart of an example process 100B that uses bytecode injection to control an application's access to resources. Process 100B starts in block 102B, where an application security management system accesses a request made by an application instance using a resource access bytecode instruction for access to a resource of a device executing the application instance. Upon detecting the request, in block 104B, the application security management system injects a validation bytecode instruction to complete execution before the request. The validation bytecode instruction is based at least in part on the request and one or more states of the application instance. In block 108B, execution of the validation bytecode instruction determines whether access is prevented or not. If access is not prevented, in block 110B, the resource access bytecode instructions is executed. On the other hand, in block 112B, the application security management system uses the validation bytecode instruction to prevent access to the resource if one or more conditions are satisfied based at least in part on the one or more states of the application instance. Whether access is prevented or not, in block 114B, the application security management system logs the request and metadata to a resource access log. In block 116B, a determination is made as to whether there are more requests to handle. If so, process 100B proceeds back to block 102B. If not, process 100B ends.

In one embodiment, the bytecode instruction that originated from a request by the application instance to access the resource (“resource access bytecode instruction”) includes metadata that identifies a state of the application instance (e.g., foreground, background, foreground for t seconds immediately before and up to the access, background for t seconds immediately before and up to the access, foreground using application interface A of the application, foreground using application interface B of the application, foreground using application interface C of the application, foreground after using application interface D of another application, other foreground states or background states, and/or any sequential pattern or combination thereof). The metadata may be used by a process triggered by the resource access bytecode instruction or another instruction based on the resource access bytecode instruction to determine if the application state is one where the requested resource access should be granted (e.g., resource access that is commonly granted or whitelisted to be granted in association with the application state, as opposed to resource access that is uncommonly granted or blacklisted in association with the application state).

In one embodiment, the application security management system detects a resource access bytecode instruction and injects a validation bytecode instruction before the resource access bytecode instruction such that the validation bytecode instruction is executed to determine whether resource access should be granted or not by the subsequent resource access bytecode instruction. In other words, the validation bytecode instruction controls access to resources for which the resource access bytecode instruction attempts to access. The resource access bytecode instruction may be detected by monitoring a bytecode instruction call stack of bytecode instructions to be executed on behalf of the application. For example, the bytecode instruction call stack may be monitored by a bytecode interpreter that translates the bytecode instructions to machine code. The bytecode interpreter as implemented to inject validation bytecode instructions serves as a layer between the application and the hardware-accessible resources to prevent resource access for purposes other than legitimate purposes. The application may be responsible for generating a first set of bytecode instructions to use the resources to provide application functionality, and the application security management system may be responsible for generating a second set of bytecode instructions to use for controlling access to the requested resources. Some data values in the different sets of bytecode instructions may be encrypted according to different keys such that some values of the application-generated instructions (resource access bytecode instructions) are opaque to some values of the application security management bytecode instructions (validation bytecode instructions), and such that some values of the validation bytecode instructions are opaque to some values of the resource access bytecode instructions.

The application security management system may detect resource access bytecode instructions on the call stack and inject validation bytecode instructions before each of the detected resource access bytecode instructions, or before each of the resource access bytecode instructions that satisfy certain criteria. For example, the injected validation bytecode instruction may be added only when the application is in a certain state, such as a background state or an inactive state, and not when the application is in another state such as a foreground state or an active state.

The application security management system may evaluate one or more initial conditions that indicate a likelihood that the resource access bytecode instructions may require further analysis or a likelihood that the resource access bytecode instructions are not for legitimate purposes to determine whether or not the resource access bytecode instructions require validation. If the resource access bytecode instructions require validation, validation bytecode instructions may be injected or not to validate the resource access bytecode instructions, such as by checking more complex conditions that may be based on a history or pattern of application access to resources. Checking these more complex conditions may require more processing time and more runtime resources that are not consumed when the initial conditions indicate that the further analysis is not required. In this manner, the additional processing may be saved, and low risk scenarios of resource access requests may be executed without delay at the instruction level depending on whether the initial conditions are satisfied.

If execution of the validation bytecode instruction indicates that access is allowed, a handle for interacting with the resource or other data from the resource may be returned to the application by the resource access bytecode instruction. For example, the validation bytecode instruction may check for a whitelisted set of application states or a whitelisted set of combinations or tuples of application states and resource access requests. For example, the application security management system's rules may require more active application engagement for some resources as compared to other resources. A camera resource may, for example, be allowed when the application is actively engaged in the foreground, but a microphone resource may, for example, be allowed when the application was recently actively engaged in the foreground even if the application is in the background at the time the request is processed.

A code assurance process may validate that the application consistently uses the resource access bytecode instructions being monitored for resource access and does not attempt to access resources without using the monitored bytecode instructions. In this manner, the code assurance may validate that the application is not attempting to circumvent the application security management system.

In one embodiment, the OrbuCode rules engine applies rules for requests being processed by the application security management system. The rules engine uses bytecode instructions to apply and interpret the rules. A library of instructions is provided to the application and used to monitor communication being transmitted from the application. The library is implemented to detect whether the application is attempting to send an outgoing communication. If so, information is logged, and the application security management system determines whether to permit or reject such a communication.

In one embodiment, a request engine implements validation logic through the execution of individual instructions contained within an OrbuCode language that provides instructions in the form of bytecode. In various embodiments, the engine itself performs the application security management system's validations using bytecode without impacting the user experience. The OrbuCode engine may be responsible for validating network requests, software development kit (SDK) invocations, and any other evaluation of the application.

In one embodiment, the request validation workflow includes software assurance rules that define the requirements for the assurance functions to be performed for specific data flows. Tickets may be created for the mobile engineering team to track efforts. The mobile engineering team may use tooling to create the OrbuCode engine to implement the functional assurance requirements. Enhancements may be made to the framework to add support for the functionality prompted by assurance. Updated policy file(s) containing or describing the OrbuCode engine may be created and reviewed. Updated frameworks are delivered for incorporation into client applications. The updated policy files are released, and the client applications are updated through app stores or other trusted content delivery networks to add new client frameworks. Additionally, existing client applications may retrieve updated policies and begin using them for assurance functions.

The OrbuCode instructions provide functionality for performing some portion of request evaluation. An instruction may be uniquely identified with a numerical value: the OpCode. Each operand defines its own modifiers and supplementary information in the form of operands. An actual line of runnable code confirming to an instruction is a statement. The collection of available instructions are an instruction set. Instructions may be added over time, with each new instruction securing a unique and unused OpCode.

In some embodiments, instructions may not be removed from an instruction set but may be marked as deprecated, in which code should eventually remove or replace usage. Instructions added after the initial release of an application have an associated numerical value API level. Each runtime implementation has an implemented API level for which the release properly and fully allows instructions defined at that level. Runtime checks can be used in to skip statements or code blocks entirely, in case the code is too new for the existing deployment.

In one embodiment, each instruction returns a return code value from a fixed collection of enumerated options. For example, there may be return code values to indicate true, false, found, matches, etc. Each instruction may define which return codes it may return. The statement contains a control flow value from a fixed collection of enumerated options. For example, a control flow could be used to specify the request should be rejected if the return code from the instruction was true, or if the return code from the instruction was false.

A collection of one or more statements creates a code block. Code blocks have two purposes: to group a collection of statements as a single entity for testing, reuse, or direct invocation, and to provide local storage with a scope of that block. Storage for simple data available for the entire evaluation of a request is provided in the form of a request global scope storage. New instructions may be added to the instruction set. Any addition of instructions may involve an increase in the API level. By respecting the API level, existing deployed OrbuCode or other bytecode interpreters may handle, without causing a failure, newer sources by ignoring those sections of code identified with a minimum API level requirement.

Constant values, including primitives such as strings, numbers, floats, binary data, and collections (arrays, sets, maps, etc.) may be stored in data tables and referenced by an index. The generation of OrbuCode or other bytecode instructions may generally be compiled or preprocessed using a higher level language or tool that will create these data tables and references automatically.

In one embodiment, the bytecode interpreter is a platform-specific engine that can read and execute OrbuCode, such as a C++, Kotlin, or Swift interpreter.

In one embodiment, a data word is 32 bits (little endian) regardless of processor or OS architecture. In an example, an instruction may include six 32-bit values, or 192 bits total. Of this, the first 32 bits may be used to identify the instruction and provide the control flow value. An instruction in OrbuCode may be immutable in the sense that instructions are not allowed to be rewritten with alternate values.

An example instruction may be formatted as follows:

| Word | 1 | | | | | | | |
|---|---|---|---|---|---|---|---|---|
| Byte | 4 . . . 3 | | | | 2 | 1 | | 2-6 |
| Bits | 32 | 31 | 30 . . . 27 | 26 . . . 17 | 16 . . . 9 | 8 . . . 5 | 4 . . . 1 | 5-24 |
| Purpose | | Expected | Data | OpCode | Unique | Expected | Control | Operands |
| | | Return | Table | | to each | Return | Flow | 1-5 |
| | | Code | Number | | control | Code | | |
| | | Comparison | | | flow | | | |

In the example, bytes 5 through 24 may be used for operands for the instruction. An instruction may define and use the space any way that suits the instruction. The instruction header may include the first OrbuCodeWord, or 32 bits of the instruction. In the example, the word includes two reserved bits, an optional data table reference, 10 bits to define the OpCode, an 8-bit value specific to the control flow, and the 8 bit control flow code.

When an application vendor or assurances provider generates a build, the application security management system provider may provide a binary of the library, which is integrated into the application in the build system. The application vendor sends the application security management system vendor an integrated app that includes calls to the library at the bytecode level. Then the application security management system vendor runs assurance checks (which are currently static checks but could later be dynamic checks) to see if the library is appropriately integrated with the code (e.g., when calls are made).

Within the application security management system, a set of rules are triggered by bytecode integrated with the application, and the rules are used to determine whether to allow or disallow the request. Further, logging is performed to log the attempt and the decision. The logs are sent to the cloud provider back-end endpoints (e.g., an alerts/telemetry service) for further analysis by security analysts, to ensure the application is not attempting to access or distribute data in a way that violates data security policies. When sending back the requests to the endpoints, the requests are not just streaming back to the endpoints costing processing time by the application but are being processed using sampling, a neural network or other models, to decide what traffic is sent back to the endpoints.

Expert analysis of the logs may feed back into the configuration service for reconfiguring the rules to discover different patterns that are likely to result in inappropriate use of on-device sensor data.

In various embodiments, applications and devices secured using the application security management system described herein using bytecode injected triggers of rule evaluation will have higher levels of trust and security than applications not secured using the application security management system in this manner. The bytecode level of integration prevents workarounds by the application, facilitating consistent and reliable monitoring of the application. The bytecode level of integration also promotes security checks that are effective against even highly sophisticated and complex applications.

There is novelty in using bytecode integrated into a production application to trigger analysis of requests to use sensor data or data outside of a wrapper of the application security management system to determine if the request violates data security policies. The bytecode integration protects against workarounds that might otherwise exist with higher-level integrations.

### Computer System Architecture

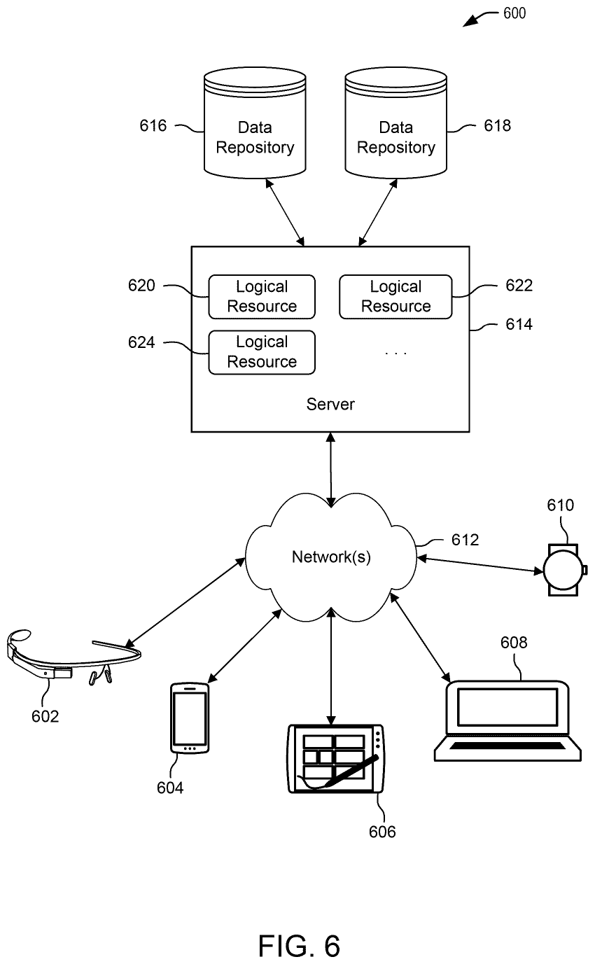

FIG. 6 depicts a simplified diagram of a distributed system 600 for implementing an embodiment. In the illustrated embodiment, distributed system 600 includes one or more client computing devices 602, 604, 606, 608, and/or 610 coupled to a server 614 via one or more communication networks 612. Clients computing devices 602, 604, 606, 608, and/or 610 may be configured to execute one or more applications.

In various aspects, server 614 may be adapted to run one or more services or software applications that enable techniques for controlling an application's access to resources based on application status and/or other metadata.

In certain aspects, server 614 may also provide other services or software applications that can include non-virtual and virtual environments. In some aspects, these services may be offered as web-based or cloud services, such as under a Software as a Service (SaaS) model to the users of client computing devices 602, 604, 606, 608, and/or 610. Users operating client computing devices 602, 604, 606, 608, and/or 610 may in turn utilize one or more client applications to interact with server 614 to utilize the services provided by these components.

In the configuration depicted in FIG. 6, server 614 may include one or more components 620, 622 and 624 that implement the functions performed by server 614. These components may include software components that may be executed by one or more processors, hardware components, or combinations thereof. It should be appreciated that various different system configurations are possible, which may be different from distributed system 600. The embodiment shown in FIG. 6 is thus one example of a distributed system for implementing an embodiment system and is not intended to be limiting.

Users may use client computing devices 602, 604, 606, 608, and/or 610 for techniques for controlling an application's access to resources based on application status and/or other metadata in accordance with the teachings of this disclosure. A client device may provide an interface that enables a user of the client device to interact with the client device. Although FIG. 6 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle Linux and Google Chrome OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 612 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 612 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 614 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 614 can include one or more virtual machines running virtual operating systems, or other computing architectures involving virtualization such as one or more flexible pools of logical storage devices that can be virtualized to maintain virtual storage devices for the server. In various aspects, server 614 may be adapted to run one or more services or software applications that provide the functionality described in the foregoing disclosure.

The computing systems in server 614 may run one or more operating systems including any of those discussed above, as well as any commercially available server operating system. Server 614 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 614 may include one or more applications to analyze and consolidate data feeds and/or event updates received from users of client computing devices 602, 604, 606, 608, and/or 610. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 614 may also include one or more applications to display the data feeds and/or real-time events via one or more display devices of client computing devices 602, 604, 606, 608, and/or 610.

Distributed system 600 may also include one or more data repositories 616, 618. These data repositories may be used to store data and other information in certain aspects. For example, one or more of the data repositories 616, 618 may be used to store information for techniques for controlling an application's access to resources based on application status and/or other metadata. Data repositories 616, 618 may reside in a variety of locations. For example, a data repository used by server 614 may be local to server 614 or may be remote from server 614 and in communication with server 614 via a network-based or dedicated connection. Data repositories 616, 618 may be of different types. In certain aspects, a data repository used by server 614 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 616, 618 may also be used by applications to store application data. The data repositories used by applications may be of different types such as, for example, a key-value store repository, an object store repository, or a general storage repository supported by a file system.

In one embodiment, server 614 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

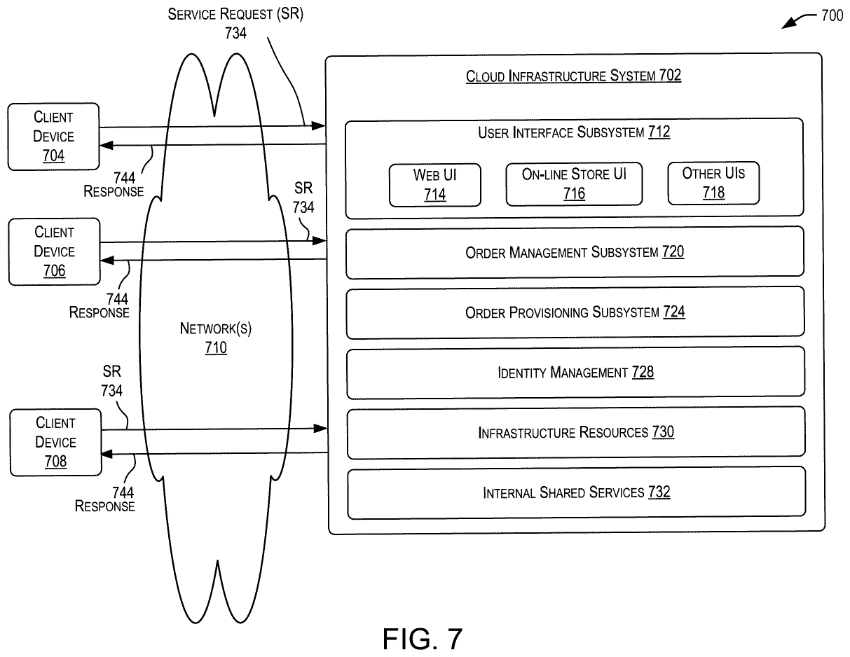

FIG. 7 is a simplified block diagram of a cloud-based system environment in which an application's access to resources is controlled based on application status and/or other metadata, in accordance with certain aspects. In the embodiment depicted in FIG. 7, cloud infrastructure system 702 may provide one or more cloud services that may be requested by users using one or more client computing devices 704, 706, and 708. Cloud infrastructure system 702 may comprise one or more computers and/or servers that may include those described above for server 614. The computers in cloud infrastructure system 702 may be organized as general purpose computers, specialized server computers, server farms, server clusters, or any other appropriate arrangement and/or combination.

Network(s) 710 may facilitate communication and exchange of data between clients 704, 706, and 708 and cloud infrastructure system 702. Network(s) 710 may include one or more networks. The networks may be of the same or different types. Network(s) 710 may support one or more communication protocols, including wired and/or wireless protocols, for facilitating the communications.

The embodiment depicted in FIG. 7 is only one example of a cloud infrastructure system and is not intended to be limiting. It should be appreciated that, in some other aspects, cloud infrastructure system 702 may have more or fewer components than those depicted in FIG. 7, may combine two or more components, or may have a different configuration or arrangement of components. For example, although FIG. 7 depicts three client computing devices, any number of client computing devices may be supported in alternative aspects.

The term cloud service is generally used to refer to a service that is made available to users on demand and via a communication network such as the Internet by systems (e.g., cloud infrastructure system 702) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 710 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 702 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 702 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 702. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 702. Cloud infrastructure system 702 then performs processing to provide the services requested in the tenant's subscription order. Cloud infrastructure system 702 may be configured to provide one or even multiple cloud services.

Cloud infrastructure system 702 may provide the cloud services via different deployment models. In a public cloud model, cloud infrastructure system 702 may be owned by a third party cloud services provider and the cloud services are offered to any general public tenant, where the tenant can be an individual or an enterprise. In certain other aspects, under a private cloud model, cloud infrastructure system 702 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 702 and the services provided may be shared by several organizations in a related community. Various other models such as hybrids of the above mentioned models may also be used.

Client computing devices 704, 706, and 708 may be of different types (such as devices 602, 604, 606, and 608 depicted in FIG. 6) and may be capable of operating one or more client applications. A user may use a client device to interact with cloud infrastructure system 702, such as to request a service provided by cloud infrastructure system 702.

In some aspects, the processing performed by cloud infrastructure system 702 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 702 for determining the intent of an utterance. The data used for this analysis may include structured data (e.g., data stored in a database or structured according to a structured model) and/or unstructured data (e.g., data blobs (binary large objects)).

As depicted in the embodiment in FIG. 7, cloud infrastructure system 702 may include infrastructure resources 730 that are utilized for facilitating the provision of various cloud services offered by cloud infrastructure system 702. Infrastructure resources 730 may include, for example, processing resources, storage or memory resources, networking resources, and the like.

In certain aspects, to facilitate efficient provisioning of these resources for supporting the various cloud services provided by cloud infrastructure system 702 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 702 may itself internally use services 732 that are shared by different components of cloud infrastructure system 702 and which facilitate the provisioning of services by cloud infrastructure system 702. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 702 may comprise multiple subsystems. These subsystems may be implemented in software, or hardware, or combinations thereof. As depicted in FIG. 7, the subsystems may include a user interface subsystem 712 that enables users of cloud infrastructure system 702 to interact with cloud infrastructure system 702. User interface subsystem 712 may include various different interfaces such as a web interface 714, an online store interface 716 where cloud services provided by cloud infrastructure system 702 are advertised and are purchasable by a consumer, and other interfaces 718. For example, a tenant may, using a client device, request (service request 734) one or more services provided by cloud infrastructure system 702 using one or more of interfaces 714, 716, and 718. For example, a tenant may access the online store, browse cloud services offered by cloud infrastructure system 702, and place a subscription order for one or more services offered by cloud infrastructure system 702 that the tenant wishes to subscribe to. The service request may include information identifying the tenant and one or more services that the tenant desires to subscribe to. For example, a tenant may place a subscription order for a chatbot related service offered by cloud infrastructure system 702. As part of the order, the client may provide information identifying the input (e.g. utterances).

In certain aspects, such as the embodiment depicted in FIG. 7, cloud infrastructure system 702 may comprise an order management subsystem (OMS) 720 that is configured to process the new order. As part of this processing, OMS 720 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 720 may then invoke the order provisioning subsystem (OPS) 724 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 724 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 702 may send a response or notification 744 to the requesting tenant to indicate when the requested service is now ready for use. In some instances, information (e.g., a link) may be sent to the tenant that enables the tenant to start using and availing the benefits of the requested services.

Cloud infrastructure system 702 may provide services to multiple tenants. For each tenant, cloud infrastructure system 702 is responsible for managing information related to one or more subscription orders received from the tenant, maintaining tenant data related to the orders, and providing the requested services to the tenant or clients of the tenant. Cloud infrastructure system 702 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 702 may provide services to multiple tenants in parallel. Cloud infrastructure system 702 may store information for these tenants, including possibly proprietary information. In certain aspects, cloud infrastructure system 702 comprises an identity management subsystem (IMS) 728 that is configured to manage tenant's information and provide the separation of the managed information such that information related to one tenant is not accessible by another tenant. IMS 728 may be configured to provide various security-related services such as identity services, such as information access management, authentication and authorization services, services for managing tenant identities and roles and related capabilities, and the like.

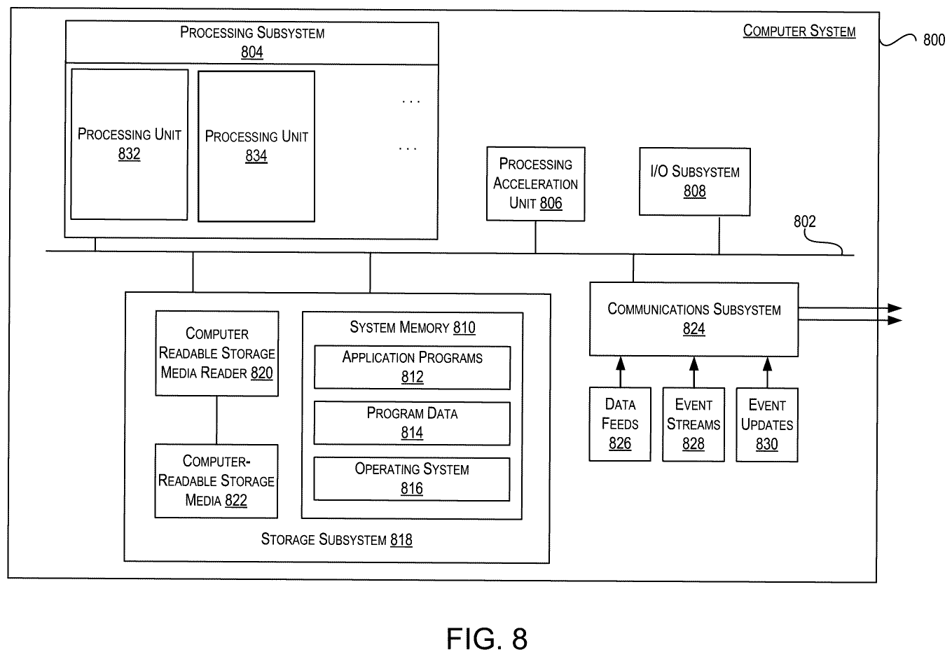

FIG. 8 illustrates an exemplary computer system 800 that may be used to implement certain aspects. As shown in FIG. 8, computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. Storage subsystem 818 may include non-transitory computer-readable storage media including storage media 822 and a system memory 810.

Bus subsystem 802 provides a mechanism for letting the various components and subsystems of computer system 800 communicate with each other as intended. Although bus subsystem 802 is shown schematically as a single bus, alternative aspects of the bus subsystem may utilize multiple buses. Bus subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of computer system 800 and may comprise one or more processors, application specific integrated circuits (ASICs), or field programmable gate arrays (FPGAs). The processors may be single core or multicore processors. The processing resources of computer system 800 can be organized into one or more processing units 832, 834, etc. A processing unit may include one or more processors, one or more cores from the same or different processors, a combination of cores and processors, or other combinations of cores and processors. In some aspects, processing subsystem 804 can include one or more special purpose co-processors such as graphics processors, digital signal processors (DSPs), or the like. In some aspects, some or all of the processing units of processing subsystem 804 can be implemented using customized circuits, such as application specific integrated circuits (ASICs), or field programmable gate arrays (FPGAs).

In some aspects, the processing units in processing subsystem 804 can execute instructions stored in system memory 810 or on computer readable storage media 822. In various aspects, the processing units can execute a variety of programs or code instructions and can maintain multiple concurrently executing programs or processes. At any given time, some or all of the program code to be executed can be resident in system memory 810 and/or on computer-readable storage media 822 including potentially on one or more storage devices. Through suitable programming, processing subsystem 804 can provide various functionalities described above. In instances where computer system 800 is executing one or more virtual machines, one or more processing units may be allocated to each virtual machine.

In certain aspects, a processing acceleration unit 806 may optionally be provided for performing customized processing or for off-loading some of the processing performed by processing subsystem 804 so as to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information to computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 818 provides a repository or data store for storing information and data that is used by computer system 800. Storage subsystem 818 provides a tangible non-transitory computer-readable storage medium for storing the basic programming and data constructs that provide the functionality of some aspects. Storage subsystem 818 may store software (e.g., programs, code modules, instructions) that when executed by processing subsystem 804 provides the functionality described above. The software may be executed by one or more processing units of processing subsystem 804. Storage subsystem 818 may also provide a repository for storing data used in accordance with the teachings of this disclosure.

Storage subsystem 818 may include one or more non-transitory memory devices, including volatile and non-volatile memory devices. As shown in FIG. 8, storage subsystem 818 includes a system memory 810 and a computer-readable storage media 822. System memory 810 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 800, such as during start-up, may typically be stored in the ROM. The RAM typically contains data and/or program modules that are presently being operated and executed by processing subsystem 804. In some implementations, system memory 810 may include multiple different types of memory, such as static random access memory (SRAM), dynamic random access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 822 may store programming and data constructs that provide the functionality of some aspects. Computer-readable media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, digital video disc (DVD), a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 818 may also include a computer-readable storage media reader 820 that can further be connected to computer-readable storage media 822. Reader 820 may receive and be configured to read data from a memory device such as a disk, a flash drive, etc.

In certain aspects, computer system 800 may support virtualization technologies, including but not limited to virtualization of processing and memory resources. For example, computer system 800 may provide support for executing one or more virtual machines. In certain aspects, computer system 800 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices. For example, the communications subsystem may be used to transmit a response to a user regarding the inquiry for a chatbot.

Communications subsystem 824 may support both wired and/or wireless communication protocols. For example, in certain aspects, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 824 can provide wired network connectivity (e.g., Ethernet) in addition to or instead of a wireless interface.

Communications subsystem 824 can receive and transmit data in various forms. For example, in some aspects, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
executing an application instance that uses an interface that wraps external resource access functionality of the application instance; wherein the interface is configured to constrain the external resource access functionality based at least in part on information obtained from the application instance about states of the application instance;
using the interface to allow access from the application instance to one or more external resources, and logging, in a particular log, metadata about functionality carried out by the application instance in relation to access to the one or more external resources;
receiving a call to the interface from the application instance, wherein the call comprises a request for particular access to a particular resource external to the application instance;
receiving particular metadata about functionality carried out by the application instance in association with the request;
determining a particular use-case of a plurality of candidate use-cases for the request based at least in part on the particular metadata;
comparing the particular use-case to a set of rules that map different use-cases of the plurality of candidate use-cases to different candidate external resources to determine if the request to the particular resource is valid for the particular use-case; wherein the set of rules is based at least in part on a first set of historical requests to external resources that are invalid and a second set of historical requests to external resources that are valid;
based on a determination that the request to the particular resource is not valid for the particular use-case, rejecting the request between the application instance and the particular resource external to the application instance; and
logging the rejected request to the particular log.

2. The computer-implemented method of claim 1, wherein the determination that the request to the particular resource is not valid for the particular use-case is based at least in part on a determination that the particular use-case for the request does not satisfy a particular rule, and wherein the method further comprises:
logging the determination for the particular rule to the particular log in association with the rejected request.

3. The computer-implemented method of claim 1, wherein the resource external to the application is a hardware component of a device on which the application instance is executed.

4. The computer-implemented method of claim 1, wherein the resource external to the application is a cache server for the application instance, wherein the request is to access cached data stored on the cache server, and wherein the method further comprises:
generating an initial hash value of the cached data of the cache server;
in response to receiving the call to the interface from the application instance, generating a current hash value of the cached data of the cache server; and
comparing the initial hash value and the current hash value, wherein the determination that the request to the particular resource is not valid for the particular use-case is based at least in part on the initial hash value being different from the current hash value.

5. The computer-implemented method of claim 1, further comprising:
determining the particular resource external to the application instance is a content distribution network;
adding a security header to the request, wherein the security header restricts access of the content distribution network to external data sources for generating a response to the request; and
sending the request to the content distribution network.

6. The computer-implemented method of claim 1, further comprising obtaining a current state of the particular resource, wherein the determination that the request to the particular resource is not valid for the particular use-case is based at least in part on a current state of the particular resource.

7. The computer-implemented method of claim 1, further comprising:
in response to the determination that the request to the particular resource is not valid for the particular use-case, recording user input to validate the request to the particular resource.

8. The computer-implemented method of claim 1, wherein using the interface to allow access from the application instance to the one or more external resources comprises:
connecting to the one or more external resources;
retrieving particular data from the particular resource;
using a machine learning model to determine a subset of the particular data that is permitted for access by the application instance; and
sending the subset of data to the application instance.

9. The computer-implemented method of claim 1, wherein the method further comprises:
receiving a new rule from an application security service, wherein the new rule is based at least in part on analysis of the particular log; and
storing the new rule in the set of rules, wherein the determination that the request to the particular resource is not valid for the particular use-case is based at least in part on the new rule.

10. The computer-implemented method of claim 1, wherein the set of rules is one set of rules of a plurality of sets of rules, wherein each set of rules of the plurality of sets of rules is associated with a region,
and wherein the set of rules is used due to the region associated with the set of rules being the region associated with the application instance.

11. A computer-program product comprising one or more non-transitory machine-readable storage media, including stored instructions configured to cause a computing system to perform a set of actions comprising:
executing an application instance that uses an interface that wraps external resource access functionality of the application instance; wherein the interface is configured to constrain the external resource access functionality based at least in part on information obtained from the application instance about states of the application instance;
using the interface to allow access from the application instance to one or more external resources, and logging, in a particular log, metadata about functionality carried out by the application instance in relation to access to the one or more external resources;
receiving a call to the interface from the application instance, wherein the call comprises a request for particular access to a particular resource external to the application instance;
receiving particular metadata about functionality carried out by the application instance in association with the request;
determining a particular use-case of a plurality of candidate use-cases for the request based at least in part on the particular metadata;
comparing the particular use-case to a set of rules that map different use-cases of the plurality of candidate use-cases to different candidate external resources to determine if the request to the particular resource is valid for the particular use-case; wherein the set of rules is based at least in part on a first set of historical requests to external resources that are invalid and a second set of historical requests to external resources that are valid;
based on a determination that the request to the particular resource is not valid for the particular use-case, rejecting the request between the application instance and the particular resource external to the application instance; and
logging the rejected request to the particular log.

12. The computer-program product of claim 11, wherein the determination that the request to the particular resource is not valid for the particular use-case is based at least in part on a determination that the particular use-case for the request does not satisfy a particular rule, and wherein the set of actions further comprises:
logging the determination for the particular rule to the particular log in association with the rejected request.

13. The computer-program product of claim 11, wherein the resource external to the application is a cache server for the application instance, wherein the request is to access cached data stored on the cache server, and wherein the set of actions further comprises:
generating an initial hash value of the cached data of the cache server;
in response to receiving the call to the interface from the application instance, generating a current hash value of the cached data of the cache server; and
comparing the initial hash value and the current hash value, wherein the determination that the request to the particular resource is not valid for the particular use-case is based at least in part on the initial hash value being different from the current hash value.

14. The computer-program product of claim 11, wherein the set of actions further comprises:
determining the particular resource external to the application instance is a content distribution network;
adding a security header to the request, wherein the security header restricts access of the content distribution network to external data sources for generating a response to the request; and
sending the request to the content distribution network.

15. The computer-program product of claim 11, wherein the set of actions further comprises obtaining a current status of the particular resource, wherein the determination that the request to the particular resource is not valid for the particular use-case is based at least in part on a current state of the particular resource.

16. A system comprising:
one or more processors;
one or more non-transitory computer-readable media storing instructions, which, when executed by the system, cause the system to perform a set of actions comprising:
executing an application instance that uses an interface that wraps external resource access functionality of the application instance; wherein the interface is configured to constrain the external resource access functionality based at least in part on information obtained from the application instance about states of the application instance;
using the interface to allow access from the application instance to one or more external resources, and logging, in a particular log, metadata about functionality carried out by the application instance in relation to access to the one or more external resources;
receiving a call to the interface from the application instance, wherein the call comprises a request for particular access to a particular resource external to the application instance;
receiving particular metadata about functionality carried out by the application instance in association with the request;
determining a particular use-case of a plurality of candidate use-cases for the request based at least in part on the particular metadata;
comparing the particular use-case to a set of rules that map different use-cases of the plurality of candidate use-cases to different candidate external resources to determine if the request to the particular resource is valid for the particular use-case; wherein the set of rules is based at least in part on a first set of historical requests to external resources that are invalid and a second set of historical requests to external resources that are valid;
based on a determination that the request to the particular resource is not valid for the particular use-case, rejecting the request between the application instance and the particular resource external to the application instance; and
logging the rejected request to the particular log.

17. The system of claim 16, wherein the determination that the request to the particular resource is not valid for the particular use-case is based at least in part on a determination that the particular use-case for the request does not satisfy a particular rule, and wherein the set of actions further comprises:
logging the determination for the particular rule to the particular log in association with the rejected request.

18. The system of claim 16, wherein the resource external to the application is a cache server for the application instance, wherein the request is to access cached data stored on the cache server, and wherein the set of actions further comprises:
generating an initial hash value of the cached data of the cache server;
in response to receiving the call to the interface from the application instance, generating a current hash value of the cached data of the cache server; and
comparing the initial hash value and the current hash value, wherein the determination that the request to the particular resource is not valid for the particular use-case is based at least in part on the initial hash value being different from the current hash value.

19. The system of claim 16, wherein the set of actions further comprises:
determining the particular resource external to the application instance is a content distribution network;
adding a security header to the request, wherein the security header restricts access of the content distribution network to external data sources for generating a response to the request; and
sending the request to the content distribution network.

20. The system of claim 16, wherein the set of actions further comprises obtaining a current status of the particular resource, wherein the determination that the request to the particular resource is not valid for the particular use-case is based at least in part on a current state of the particular resource.
